(19) United States
(12) Patent Application Publication
(10) Pub. No.: US 2025/0220597 A1
(43) Pub. Date: Jul. 3, 2025

(54) RELAXATION OF TIME ALIGNMENT TIMER PARAMETERS

(71) Applicant: QUALCOMM INCORPORATED, San Diego, CA (US)

(72) Inventors: Jing Lei, San Diego, CA (US); Ruiming Zheng, Beijing (CN); Xipeng Zhu, San Diego, CA (US)

(21) Appl. No.: 18/846,630

(22) PCT Filed: Jun. 8, 2022
(86) PCT No.: PCT/CN2022/097580

§ 371 Date: Sep. 12, 2024

(51) Int. Cl. H04W 56/00

(52) U.S. Cl. CPC H04W 56/001

(57) ABSTRACT

Methods, systems, and devices for wireless communications are described. A user equipment (UE) may receive an indication of time alignment timer (TAT) relaxation criteria for one or more time alignment timers at the UE. The UE may transmit a request or a status report for TAT relaxation based on satisfying the time alignment timer relaxation criteria. The UE may receive an indication of TAT relaxation parameters in response to the request or status report. The UE may apply the TAT relaxation parameters to perform fewer measurements and transmit fewer measurement reports for uplink transmission. In some cases, reduced physical downlink control channel (PDCCH) monitoring occasions and extended discontinuous reception (DRX) can be jointly configured with the relaxation of TATs for the UE.

### CROSS REFERENCE

The present application is a 371 national stage filing of International PCT Application No. PCT/CN2022/097580 by Lei et al. entitled “RELAXATION OF TIME ALIGNMENT TIMER PARAMETERS,” filed Jun. 8, 2022, which is assigned to the assignee hereof, and which is expressly incorporated by reference in its entirety herein.

### TECHNICAL FIELD

The following relates to wireless communications, including relaxation of time alignment timer parameters.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support relaxation of time alignment timer (TAT) parameters. For example, the described techniques provide for relaxing TAT requirements for uplink transmission at a user equipment (UE). A UE may receive an indication of TAT relaxation criteria for one or more time alignment timers at the UE. The TAT relaxation criteria may include indicate one or more reference signal types associated with a timing advance group for the UE to measure in order to determine whether TAT relaxation can be applied. The TAT relaxation criteria may include, for example, thresholds, coefficients, evaluation metrics, and a measurement window for determining whether timing information at the UE is accurate enough or consistent enough to relax TAT requirements at the UE. The UE may evaluate whether measurements of reference signals associated with the timing advance groups, TATs, uplink channels, or uplink signals satisfy the TAT criteria. The UE may transmit a request or a status report for TAT relaxation based on satisfying the time alignment timer relaxation criteria. The UE may receive an indication of TAT relaxation parameters in response to the request or status report. The UE may perform fewer measurements and transmit fewer measurement reports for uplink transmission based on applying the TAT relaxation parameters.

A method for wireless communications at a UE is described. The method may include receiving an indication of TAT relaxation criteria for one or more TATs at the UE, transmitting a request or a status report for TAT relaxation based on satisfying the TAT relaxation criteria, and receiving an indication of TAT relaxation parameters in response to the request or status report.

An apparatus for wireless communications at a UE is described. The apparatus may include a processor, memory coupled with the processor, and instructions stored in the memory. The instructions may be executable by the processor to cause the apparatus to receive an indication of TAT relaxation criteria for one or more TATs at the UE, transmit a request or a status report for TAT relaxation based on satisfying the TAT relaxation criteria, and receive an indication of TAT relaxation parameters in response to the request or status report.

Another apparatus for wireless communications at a UE is described. The apparatus may include means for receiving an indication of TAT relaxation criteria for one or more TATs at the UE, means for transmitting a request or a status report for TAT relaxation based on satisfying the TAT relaxation criteria, and means for receiving an indication of TAT relaxation parameters in response to the request or status report.

A non-transitory computer-readable medium storing code for wireless communications at a UE is described. The code may include instructions executable by a processor to receive an indication of TAT relaxation criteria for one or more TATs at the UE, transmit a request or a status report for TAT relaxation based on satisfying the TAT relaxation criteria, and receive an indication of TAT relaxation parameters in response to the request or status report.

In some examples of the method, apparatuses, and non-transitory computer-readable medium described herein, receiving the indication of the TAT relaxation criteria may include operations, features, means, or instructions for receiving an indication of one or more timing advance groups, an indication of one or more reference signal types associated with a timing advance group of the one or more timing advance groups, one or more measurement thresholds, one or more filtering coefficients, one or more evaluation metrics, or any combination thereof, for a reference signal measurement to satisfy the TAT relaxation criteria, where the indication of the TAT relaxation criteria further indicates a resource configuration and scheduling information for transmission or retransmission, or both, of the request or the status report for TAT relaxation.

In some examples of the method, apparatuses, and non-transitory computer-readable medium described herein, receiving the indication of the TAT relaxation criteria may include operations, features, means, or instructions for receiving the indication of the TAT relaxation criteria for a timing advance group, one or more TATs, one or more uplink signals, one or more uplink channels, or any combination thereof.

In some examples of the method, apparatuses, and non-transitory computer-readable medium described herein, transmitting the status report may include operations, features, means, or instructions for transmitting the status report indicating that a status of the UE satisfies the TAT relaxation criteria for one or more uplink signals or uplink channels in a timing advance group and requesting for the TAT relaxation for the one or more uplink signals or uplink channels in the timing advance group.

In some examples of the method, apparatuses, and non-transitory computer-readable medium described herein, transmitting the request may include operations, features, means, or instructions for requesting for TAT relaxation for a timing advance group, one or more TATs, one or more uplink signals, one or more uplink channels, or any combination thereof.

In some examples of the method, apparatuses, and non-transitory computer-readable medium described herein, transmitting the request or the status report may include operations, features, means, or instructions for transmitting the request or the status report via a random access message, a configured grant transmission, a small data transmission, a periodic, semi-persistent, or aperiodic channel state information report, a scheduling request, a medium access control (MAC) control message with a dedicated MAC header, an uplink control information message, a UE assistance information message, or a UE capability message, or any combination thereof.

Some examples of the method, apparatuses, and non-transitory computer-readable medium described herein may further include operations, features, means, or instructions for transmitting a retransmission of the request or the status report for TAT relaxation based on not receiving a response to the request or based on a collision with downlink channels or higher priority uplink signaling.

In some examples of the method, apparatuses, and non-transitory computer-readable medium described herein, the retransmission of the request or the status report may be based on a link adaptation procedure, a random back-off procedure, a power control procedure, a coverage enhancement procedure, a transmit beam switching procedure, a bandwidth part switching procedure, an uplink carrier switching procedure, or any combination thereof.

In some examples of the method, apparatuses, and non-transitory computer-readable medium described herein, receiving the indication of the TAT relaxation parameters may include operations, features, means, or instructions for receiving an indication of one or more timing advance groups, one or more TATs, one or more TAT identifiers, one or more uplink signals, one or more uplink channels, or any combination thereof, enabled for TAT relaxation.

In some examples of the method, apparatuses, and non-transitory computer-readable medium described herein, receiving the indication of the TAT relaxation parameters may include operations, features, means, or instructions for receiving an indication of a time window duration for applying the TAT relaxation, a configuration for reduced monitoring occasions for downlink control channel within the time window duration, a configuration of extended discontinuous reception within the time window duration, or any combination thereof.

In some examples of the method, apparatuses, and non-transitory computer-readable medium described herein, receiving the indication of the TAT relaxation parameters may include operations, features, means, or instructions for receiving control signaling configuring a set of reference signal resources for measurements associated with TAT management, radio resource management (RRM), radio link monitoring (RLM), beam management, beam failure detection, link adaptation, power control, or any combination thereof.

Some examples of the method, apparatuses, and non-transitory computer-readable medium described herein may further include operations, features, means, or instructions for applying the TAT relaxation parameters starting no earlier than a last symbol or a last slot of a downlink channel carrying the indication of the TAT relaxation parameters, where a cell-specific or UE-specific time offset with respect to the last symbol or last slot of receiving the indication for the TAT relaxation parameters may be received via higher layer signaling.

Some examples of the method, apparatuses, and non-transitory computer-readable medium described herein may further include operations, features, means, or instructions for receiving an indication of a start time to apply the TAT relaxation parameters via downlink control information, a MAC control element (CE), system information, or radio resource control (RRC) signaling, or any combination thereof.

Some examples of the method, apparatuses, and non-transitory computer-readable medium described herein may further include operations, features, means, or instructions for measuring one or more reference signals to obtain one or more reference signal measurements and determining that the TAT relaxation criteria may be satisfied based on the one or more reference signal measurements, a capability of the UE, and thresholds for the one or more reference signal measurements.

Some examples of the method, apparatuses, and non-transitory computer-readable medium described herein may further include operations, features, means, or instructions for transmitting one or more uplink reference signals, data or control messages in accordance with the TAT relaxation parameters.

In some examples of the method, apparatuses, and non-transitory computer-readable medium described herein, receiving the indication of the TAT relaxation parameters may include operations, features, means, or instructions for receiving an indication of the TAT relaxation criteria with relaxation criteria for RRM, RLM, beam management, beam failure detection, or any combination thereof.

In some examples of the method, apparatuses, and non-transitory computer-readable medium described herein, transmitting the request or the status report may include operations, features, means, or instructions for transmitting the request or the status report while operating in an idle state, an inactive state, or a connected state.

In some examples of the method, apparatuses, and non-transitory computer-readable medium described herein, the indication of the TAT relaxation criteria or the indication of the TAT relaxation parameters, or both, may be received via downlink control information, a MAC CE, RRC signaling, a multicast message, or a broadcast message, or any combination thereof.

In some examples of the method, apparatuses, and non-transitory computer-readable medium described herein, transmitting the status report may include operations, features, means, or instructions for transmitting the request or the status report for multiple timing advance groups multiplexed in a single transmission of UE.

A method for wireless communications at a network entity is described. The method may include transmitting an indication of TAT relaxation criteria for one or more TATs at a UE, receiving a request or a status report for TAT relaxation based on satisfying the TAT relaxation criteria, and transmitting an indication of TAT relaxation parameters in response to the request.

An apparatus for wireless communications at a network entity is described. The apparatus may include a processor, memory coupled with the processor, and instructions stored in the memory. The instructions may be executable by the processor to cause the apparatus to transmit an indication of TAT relaxation criteria for one or more TATs at a UE, receive a request or a status report for TAT relaxation based on satisfying the TAT relaxation criteria, and transmit an indication of TAT relaxation parameters in response to the request.

Another apparatus for wireless communications at a network entity is described. The apparatus may include means for transmitting an indication of TAT relaxation criteria for one or more TATs at a UE, means for receiving a request or a status report for TAT relaxation based on satisfying the TAT relaxation criteria, and means for transmitting an indication of TAT relaxation parameters in response to the request.

A non-transitory computer-readable medium storing code for wireless communications at a network entity is described. The code may include instructions executable by a processor to transmit an indication of TAT relaxation criteria for one or more TATs at a UE, receive a request or a status report for TAT relaxation based on satisfying the TAT relaxation criteria, and transmit an indication of TAT relaxation parameters in response to the request.

In some examples of the method, apparatuses, and non-transitory computer-readable medium described herein, transmitting the indication of the TAT relaxation criteria may include operations, features, means, or instructions for transmitting an indication of one or more timing advance groups, one or more reference signal types associated with a timing advance group of the one or more timing advance groups, one or more measurement thresholds, one or more filtering coefficients, one or more evaluation metrics, or any combination thereof, for a reference signal measurement to satisfy the TAT relaxation criteria, where the indication of the TAT relaxation criteria further indicates a resource configuration and scheduling information for transmission or retransmission, or both, of the request or the status report for TAT relaxation.

In some examples of the method, apparatuses, and non-transitory computer-readable medium described herein, transmitting the indication of the TAT relaxation criteria may include operations, features, means, or instructions for transmitting the indication of the TAT relaxation criteria for a timing advance group, one or more TATs, one or more uplink signals, one or more uplink channels, or any combination thereof.

In some examples of the method, apparatuses, and non-transitory computer-readable medium described herein, receiving the request may include operations, features, means, or instructions for receiving the request for TAT relaxation for a timing advance group, one or more TATs, one or more uplink signals, one or more uplink channels, or any combination thereof.

In some examples of the method, apparatuses, and non-transitory computer-readable medium described herein, receiving the status report or the request may include operations, features, means, or instructions for receiving the status report indicating that a status of the UE satisfies the TAT relaxation criteria for one or more uplink signals or uplink channels in a timing advance group and receiving the request for the TAT relaxation for the one or more uplink signals or uplink channels in the timing advance group.

In some examples of the method, apparatuses, and non-transitory computer-readable medium described herein, receiving the request or the status report may include operations, features, means, or instructions for receiving the request or the status report via a random access message, a configured grant transmission, a small data transmission, a periodic, semi-persistent, or aperiodic channel state information report, a scheduling request, a MAC control message with a dedicated MAC header, an uplink control information message, a UE assistance information message, or a UE capability message, or any combination thereof.

In some examples of the method, apparatuses, and non-transitory computer-readable medium described herein, transmitting the indication of the TAT relaxation parameters may include operations, features, means, or instructions for transmitting an indication of one or more timing advance groups, one or more TATs, one or more TAT identifiers, one or more uplink signals, one or more uplink channels, or any combination thereof, enabled for TAT relaxation.

In some examples of the method, apparatuses, and non-transitory computer-readable medium described herein, transmitting the indication of the TAT relaxation parameters may include operations, features, means, or instructions for transmitting an indication of a time window duration for applying the TAT relaxation, a configuration for reduced monitoring occasions for downlink control channel within the time window duration, a configuration of extended discontinuous reception within the time window duration, or any combination thereof.

In some examples of the method, apparatuses, and non-transitory computer-readable medium described herein, transmitting the indication of the TAT relaxation parameters may include operations, features, means, or instructions for transmitting control signaling configuring a set of reference signal resources for measurements associated with TAT management, RRM, RLM, beam management, beam failure detection, link adaptation, power control, or any combination thereof.

Some examples of the method, apparatuses, and non-transitory computer-readable medium described herein may further include operations, features, means, or instructions for transmitting an indication of a start time to apply the TAT relaxation parameters via downlink control information, a MAC CE, system information, or radio resource control signaling, or any combination thereof.

In some examples of the method, apparatuses, and non-transitory computer-readable medium described herein, transmitting the indication of the TAT relaxation parameters may include operations, features, means, or instructions for transmitting an indication of the TAT relaxation criteria with relaxation criteria for RRM, RLM, beam management, beam failure detection, or any combination thereof.

In some examples of the method, apparatuses, and non-transitory computer-readable medium described herein, receiving the request or the status report may include operations, features, means, or instructions for receiving the request from a UE operating in an idle state, an inactive state, or a connected state.

In some examples of the method, apparatuses, and non-transitory computer-readable medium described herein, the indication of the TAT relaxation criteria or the indication of the TAT relaxation parameters, or both, may be transmitted via downlink control information, a MAC CE, RRC signaling, a multicast message, or a broadcast message, or any combination thereof.

### BRIEF DESCRIPTION OF THE DRAWINGS

FIG. 1 illustrates an example of a wireless communications system that supports relaxation of time alignment timer (TAT) parameters in accordance with one or more aspects of the present disclosure.

FIG. 2 illustrates an example of a wireless communications system that supports relaxation of TAT parameters in accordance with one or more aspects of the present disclosure.

FIG. 3 illustrates an example of a process flow that supports relaxation of TAT parameters in accordance with one or more aspects of the present disclosure.

FIGS. 4 and 5 show block diagrams of devices that support relaxation of TAT parameters in accordance with one or more aspects of the present disclosure.

FIG. 6 shows a block diagram of a communications manager that supports relaxation of TAT parameters in accordance with one or more aspects of the present disclosure.

FIG. 7 shows a diagram of a system including a device that supports relaxation of TAT parameters in accordance with one or more aspects of the present disclosure.

FIGS. 8 and 9 show block diagrams of devices that support relaxation of TAT parameters in accordance with one or more aspects of the present disclosure.

FIG. 10 shows a block diagram of a communications manager that supports relaxation of TAT parameters in accordance with one or more aspects of the present disclosure.

FIG. 11 shows a diagram of a system including a device that supports relaxation of TAT parameters in accordance with one or more aspects of the present disclosure.

FIGS. 12 through 15 show flowcharts illustrating methods that support relaxation of TAT parameters in accordance with one or more aspects of the present disclosure.

### DETAILED DESCRIPTION

A wireless communications system may support user equipment (UE) of different capabilities, such as reduced capability UEs or UEs capable of small data transmission, among others. In some cases, a UE may support data transmission while operating in an inactive or idle state. For example, after the UE performs a small data transmission random access channel (RACH) procedure, the UE may be capable of transmitting subsequent uplink data while in the inactive or idle state. Similarly, a UE may be capable of uplink data transmission (e.g., uplink small data transmission) while operating in an inactive or idle state after receiving a small data transmission configured grant. In some examples, a UE may be required to have accurate timing information to transmit uplink data, such as uplink data transmissions while operating in the inactive state. For example, the UE may perform or report measurements to determine an accuracy of a time alignment timer (TAT) at the UE to transmit on small data transmission configured grant resources. A UE with low mobility may have consistent timing information, due to the low mobility of the UE and the low mobility of a serving cell. Therefore, a UE with low mobility and accurate timing information may continue to have accurate timing information. However, low mobility UEs in some systems may still perform these measurements to ensure TAT and timing information accuracy, despite the timing information at the low mobility UEs being consistent.

The present disclosure provides techniques for a wireless communications system to ease or relax measurements for a TAT. For example, a UE or a network entity, or both, may implement procedures to enable relaxation of a TAT at the UE. By relaxing the TAT or TAT measurements, the UE may perform fewer measurements, transmit fewer measurement reports, and receive fewer timing advance commands, which may reduce power consumption at the UE. For example, a network entity may transmit TAT relaxation criteria to a UE. The TAT relaxation criteria may be criteria for whether a UE can support TAT relaxation, such as if the timing information at the UE is consistent or accurate enough to relax reference signal measurements and reporting. The TAT relaxation criteria may include, for example, one or more reference signal types for timing reference, one or more thresholds, one or more filtering coefficients, one or more evaluation metrics, one or more measurement windows, or any combination thereof. In some cases, the TAT relaxation criteria may include an indication of one or more TAT identifiers of one or more TATs or one or more timing advance group identifiers which may be eligible for TAT relaxation.

The UE may determine whether the UE satisfies the TAT relaxation criteria. For example, if one or more of the TATs at the UE have accurate timing information based on a reference signal measurement, or the timing information of the TAT is within a threshold indicated by the TAT relaxation criteria, the UE may determine that the TAT satisfies the TAT relaxation criteria. In some examples, the UE may transmit a request for TAT relaxation for one or more TATs or timing advance groups that satisfy the TAT relaxation criteria. Additionally, or alternatively, the UE may transmit a status report to the network entity to indicate whether the UE satisfies the TAT relaxation criteria. For example, the UE may transmit uplink assistance information to indicate which timing advance groups or TATs do satisfy or do not satisfy the TAT relaxation criteria (e.g., with or without a request for TAT relaxation).

The network entity may receive the request and transmit TAT relaxation parameters to the UE in response. The TAT relaxation parameters may ease or relax TAT requirements or measurements for one or more indicated TATs, timing advance groups, uplink channels, uplink signals, component carriers, or any combination thereof. In some cases, the TAT relaxation parameters may include one or more identifiers for one or more TATs or timing advance groups, or both. In some cases, the TAT relaxation parameters may include a duration of time for TAT relaxation associated with one or multiple TAT identifiers. The UE may apply TAT relaxation for the one or more indicated TATs, timing advance groups, uplink channels or signals, or component carriers, and the UE may transmit uplink signaling with relaxed or reduced measurements or TAT requirements in accordance with the TAT relaxation parameters.

Aspects of the disclosure are initially described in the context of wireless communications systems. Aspects of the disclosure are further illustrated by and described with reference to a process flow, apparatus diagrams, system diagrams, and flowcharts that relate to relaxation of TAT parameters.

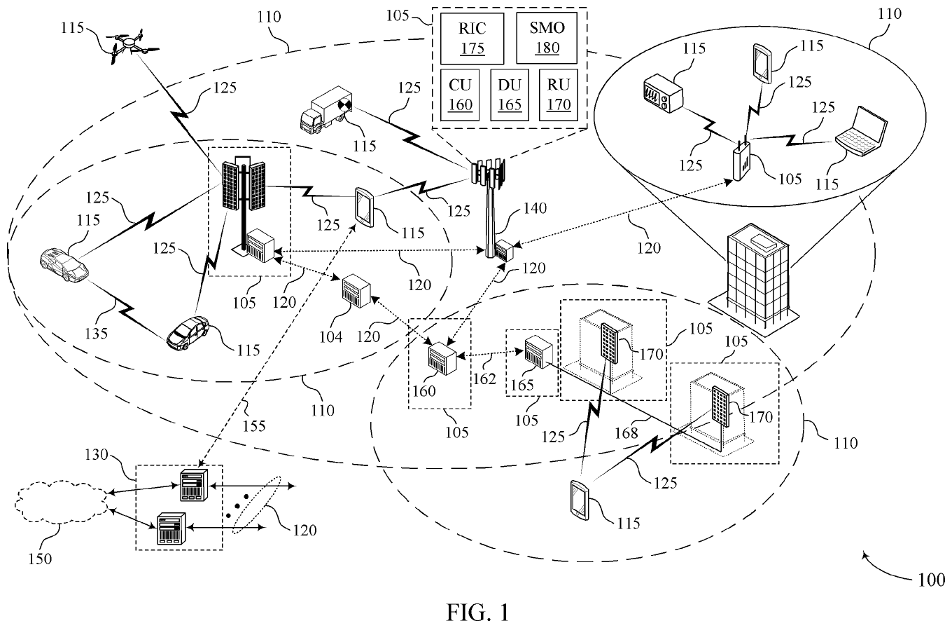

FIG. 1 illustrates an example of a wireless communications system 100 that supports relaxation of TAT parameters in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support relaxation of TAT parameters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device, etc.), a camera, a gaming device, a navigation/positioning device (e.g., GNSS (global navigation satellite system) devices based on, for example, GPS (global positioning system), Beidou, GLONASS, or Galileo, or a terrestrial-based device, etc.), a tablet computer, a laptop computer, or a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support UEs 115 of different capabilities. For example, the wireless communications system 100 may support reduced capability UEs 115 and UEs 115 which are capable of small data transmission, among others. In some cases, both two step and four step random access procedures may be supported. For example, both two step and four step random access procedures may be used for a small data transmission random access procedure by a UE 115 in an RRC inactive state. For data transmissions after completing the small data transmission random access procedure, a UE 115 may monitor for dynamic uplink grants and downlink assignments. For example, the UE 115 may monitor dynamic uplink grants and downlink assignments which may be indicated by using a cell radio network temporary identifier (C-RNTI) in a separate common search space for the random access small data transmissions. In some cases, a network entity 105 may transmit an RRC release message to terminate the small data transmission procedure (e.g., with respect to RRC). In some cases, the network, such as via the network entity 105, may transmit additional RRC messages while terminating, or to terminate, the small data transmission procedure.

In some examples, a UE 115 capable of small data transmission may receive a configured grant. The configuration of a configured grant resource for a UE small data transmission may be included in an RRC release message. The RRC release message may be used to reconfigure or release a configured grant small data transmission resource while a UE 115 is operating in an RRC inactive state. The configured grant resources for small data transmission may be valid for the UE 115 while the UE 115 is within the cell where the UE 115 received the RRC release message and transitioned into the RRC inactive state. For example, if the UE 115 leaves the cell where the UE 115 received the RRC release message, the configured grant resources for small data transmission may not be valid for the UE 115. The network, such as via a network entity 105, may support configuring one or more configured grant small data transmission resource configurations at a UE 115 while the UE 115 is in the RRC inactive state.

In some examples, a UE 115 may indicate some capabilities to a network entity 105 through an early indication. For example, the UE 115 may transmit a random access message to the network entity 105 indicating one or more supported capabilities of the UE 115. In some cases, the UE 115 may indicate a capability as a reduced capability UE 115, support for small data transmission, support for network slicing, support for coverage enhancement, or support for other features, or any combination thereof. In some examples, the early capability indication may be based on a random access preamble transmitted by the UE 115, the contents of a random access message, a resource used to transmit the random access preamble, or any combination thereof. For example, the UE 115 may transmit a feature combination preamble to indicate one or more supported features of the UE 115. Additionally, or alternatively, the UE 115 may report capabilities at an earlier or later time.

In some cases, a UE 115 may support data transmission while operating in an inactive or idle state. For example, after a UE 115 performs a small data transmission random access procedure, the UE 115 may be capable of transmitting subsequent uplink data. The UE 115 may send uplink data after receiving a second random access message for a two step small data transmission random access procedure (e.g., Message B) or after receiving a fourth random access message for a four step small data transmission random access procedure (e.g., Message 4). Similarly, a UE 115 may be capable of uplink data transmission (e.g., uplink small data transmission) while operating in an inactive or idle state after receiving a small data transmission configured grant.

In some examples, a UE 115 may be required to have accurate timing information to transmit uplink data while operating in the inactive state. For example, a UE 115 may receive a small data transmission configured grant, but the UE 115 may perform or report measurements to determine an accuracy of a TAT at the UE 115 to transmit on the small data transmission configured grant resources. In some cases, the UE 115 may monitor for reference signals, measure the reference signals, and transmit a measurement report to a network entity 105. If the timing information at the UE 115 is accurate, the UE 115 may be able to transmit uplink data messages on the small data transmission configured grant resources. In some cases, the network entity may transmit timing advance commands to the UE 115. In some cases, the timing advance commands may update timing information at the UE 115, such as if the timing information at the UE 115 is inaccurate.

A UE 115 with low mobility may have consistent timing information, due to the low mobility of the UE 115 and the low mobility of a serving cell. Therefore, a UE 115 with low mobility and accurate timing information may continue to have accurate timing information. However, low mobility UEs 115 in some systems may still perform these measurements to ensure TAT and timing information accuracy, despite the timing information at the low mobility UEs 115 being consistent.

The present disclosure provides techniques for a wireless communications system, such as the wireless communications system 100, to ease or relax measurements for one or more timers of a UE 115, such as a TAT. For example, a UE 115 or a network entity 105, or both, may implement procedures to enable relaxation of a TAT at the UE 115. By relaxing the TAT or TAT measurements, the UE 115 may perform fewer measurements, transmit fewer measurement reports, and receive fewer timing advance commands, which may reduce power consumption at the UE 115. These techniques may additionally reduce power consumption at the network, as the network entity 105 may transmit fewer timing advance commands and process fewer measurement reports from the UE 115, as well as reducing overhead used for measurements and reporting.

For example, a network entity 105 may transmit TAT relaxation criteria to a UE 115. In some cases, the network entity 105 may transmit the TAT relaxation criteria based on an indication of capabilities of the UE 115 (e.g., an early indication or a feature combination preamble indication of capabilities). The TAT relaxation criteria may be criteria for whether a UE 115 can support TAT relaxation, such as if the timing information at the UE 115 is consistent or accurate enough to relax TAT measurements and reporting. The TAT relaxation criteria may include, for example, one or more reference signal types for timing reference, one or more thresholds, one or more filtering coefficients, one or more evaluation metrics, one or more measurement windows, or any combination thereof. In some cases, the TAT relaxation criteria may include an indication of one or more TAT identifiers of one or more TATs or one or more timing advance group identifiers which may be eligible for TAT relaxation. Additionally, or alternatively, the TAT relaxation criteria may indicate separate channels, signals, carriers, or any combination thereof, eligible for TAT relaxation based on satisfying the TAT relaxation criteria.

The UE 115 may determine whether the UE 115 satisfies the TAT relaxation criteria. For example, if one or more of the TATs at the UE 115 has accurate timing information based on a reference signal measurement, or the timing information of the TAT is within a threshold indicated by the TAT relaxation criteria, the UE 115 may determine that the TAT satisfies the TAT relaxation criteria. For example, the UE 115 may be a low mobility UE 115, and the timing information at the UE 115 may infrequently change or be inaccurate. Therefore, the TATs at the UE 115 may have accurate timing information which may satisfy the TAT relaxation criteria, and the TAT requirements or measurements may be relaxed, eased, or reduced.

In some examples, the UE 115 may transmit a request for TAT relaxation for one or more TATs. For example, the UE 115 may transmit the request including one or more identifiers for one or more TATs or identifiers for one or more timing advance groups, requesting for requirements or measurements for the TATs or timing advance groups to be relaxed. In some cases, the UE 115 may request for TATs (or timing advance groups which correspond to the TATs) which satisfy the criteria to be relaxed.

Additionally, or alternatively, the UE 115 may transmit a status report to the network entity 105. The status report may indicate whether the UE 115 satisfies the TAT relaxation criteria. For example, the UE 115 may indicate that one or more timing advance groups or TATs satisfy the TAT relaxation criteria (e.g., with or without a request for TAT relaxation). If the UE 115 at least partially does not satisfy the TAT relaxation criteria, the UE 115 may indicate that the UE 115 does not at least partially satisfy the TAT relaxation criteria. For example, the UE 115 may indicate that one or more timing advance groups or TATs do not satisfy the TAT relaxation criteria. In some cases, the UE 115 may indicate that some timing advance groups do satisfy the TAT relaxation criteria and some other timing advance groups do not satisfy the TAT relaxation criteria

The network entity 105 may receive the request and transmit TAT relaxation parameters to the UE 115 in response. The TAT relaxation parameters may ease or relax TAT requirements or measurements for one or more indicated TATs, timing advance groups, uplink channels, uplink signals, component carriers, or any combination thereof. In some cases, the TAT relaxation parameters may include one or more identifiers for one or more TATs or timing advance groups, or both. In some cases, the TAT relaxation parameters may include a duration of time for TAT relaxation associated with one or multiple TAT identifiers. The UE 115 may apply TAT relaxation for the one or more indicated TATs, timing advance groups, uplink channels or signals, or component carriers, and the UE 115 may transmit uplink signaling with relaxed or reduced measurements or TAT requirements in accordance with the TAT relaxation parameters.

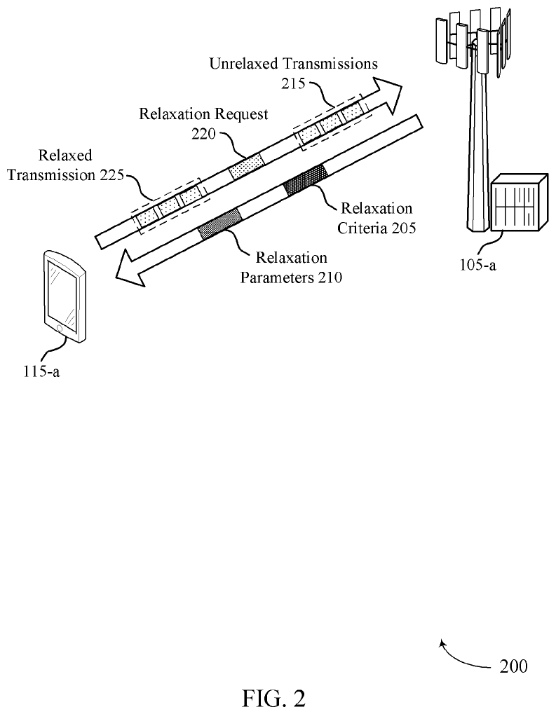

FIG. 2 illustrates an example of a wireless communications system 200 that supports relaxation of TAT parameters in accordance with one or more aspects of the present disclosure. The wireless communications system 200 may include a UE 115-a and a network entity 105-a, which may be respective examples of a UE 115 and a network entity 105 as described with reference to FIG. 1.

The wireless communications system 200 may support UEs 115 of different capabilities. For example, the wireless communications system 100 may support reduced capability UEs 115 and UEs 115 which are capable of small data transmission, among others. For example, the UE 115-a may be an example of a reduced capability UE 115. In some cases, a UE 115 may indicate some capabilities to a network entity 105 through an early indication. For example, the UE 115-a may transmit a random access message to the network entity 105-a indicating one or more supported capabilities of the UE 115. For example, the UE 115-a may indicate a capability as a reduced capability UE 115, support for small data transmission, support for network slicing, support for coverage enhancement, or support for other features, or any combination thereof.

In some cases, the UE 115-a may be capable of uplink data transmission while operating in an inactive or idle state. For example, after the UE 115-a performs a small data transmission random access procedure, the UE 115-a may be capable of subsequently transmitting uplink data. In some examples, the UE 115-a may check whether timing information at the UE 115-a is accurate in order to transmit uplink data. For example, the UE 115-a may receive a small data transmission configured grant, and the UE 115-a may perform or report measurements to determine an accuracy of a TAT at the UE 115-a to transmit on the small data transmission configured grant resources. In some cases, the UE 115-a may monitor for reference signals, measure the reference signals, and transmit a measurement report to a network entity 105. If the timing information at the UE 115-a is accurate, the UE 115-a may be able to transmit uplink data messages on the small data transmission configured grant resources (e.g., while operating in an inactive state). In some cases, the network entity 105-a may transmit timing advance commands to the UE 115-a. In some cases, the timing advance commands may update timing information at the UE 115-a, such as if the timing information at the UE 115-a is inaccurate.

For example, the UE 115-a may transmit one or more unrelaxed transmissions 215 to the network entity 105-a. The unrelaxed transmission 215 may be, for example, uplink data transmissions, such as small data transmissions. The UE 115-a or the network entity 105-a, or both, may determine whether timing information at the UE 115-a is accurate before sending the unrelaxed transmissions 215. For example, the UE 115-a may perform measurements on reference signals, and the UE 115-a may transmit measurement reports to the network entity 105-a, which may indicate whether timing information at the UE 115-a is accurate.

The wireless communications system 200 may support techniques to ease or relax measurements for one or more timers at a UE 115, such as a TAT. For example, the UE 115-a or the network entity 105-a, or both, may implement procedures to enable relaxation of a TAT at the UE 115-a. By relaxing the TAT or TAT measurements, the UE 115-a may perform fewer measurements, transmit fewer measurement reports, and receive fewer timing advance commands, which may reduce power consumption at the UE 115. These techniques may additionally reduce power consumption at the network, as the network entity 105 may transmit fewer timing advance commands and process fewer measurement reports from the UE 115, as well as reducing overhead used for measurements and reporting.

The UE 115-a may, in some cases, be a low mobility UE 115 with consistent timing information, which may be due to the low mobility of the UE 115-a and a low mobility of the network entity 105-a. Due to the consistent timing information of the UE 115-a, the UE 115-a may be eligible for TAT relaxation, reducing a number of measurements performed by the UE 115-a and measurement reports transmitted by the UE 115-a. For example, when timer relaxation is applied for a timer, such as when TAT relaxation is applied for a one or more TATs or timing advance groups, the UE 115-a may perform no, fewer, or more infrequent measurements for uplink signals, uplink carriers, or uplink channels associated with the timer, such as the one or more TATs or timing advance groups.

For example, the network entity 105-a may transmit an indication 205 of TAT relaxation criteria to the UE 115-a. In some cases, the network entity 105-a may transmit the TAT relaxation criteria based on an indication of capabilities of the UE 115-a (e.g., an early indication or a feature combination preamble indication of capabilities). The TAT relaxation criteria may be criteria for whether the UE 115-a can support TAT relaxation, such as if the timing information at the UE 115-a is consistent or accurate enough to relax TAT measurements and reporting.

The TAT relaxation criteria may include thresholds or metrics for the UE 115-a to determine whether TAT relaxation can be applied. For example, the TAT relaxation criteria may indicate one or more timing advance groups, one or more reference signal types for timing reference (e.g., which may be associated with a timing advance group o the one or more timing advance groups), one or more thresholds, one or more filtering coefficients, one or more evaluation metrics, one or more measurement windows, or any combination thereof. In some cases, the TAT relaxation criteria may include an indication of one or more TAT identifiers of one or more TATs or one or more timing advance group identifiers which may be eligible for TAT relaxation. Additionally, or alternatively, the TAT relaxation criteria may indicate separate channels, signals, carriers, or any combination thereof, eligible for TAT relaxation based on satisfying the TAT relaxation criteria.

In some cases, the TAT relaxation criteria may indicate a resource configuration or scheduling information, or both, for the UE 115-a to transmit a request for TAT relaxation or a status report for TAT relaxation. For example, a message indicating the TAT relaxation criteria may additionally indicate resources and scheduling information for the UE 115-a to send a message indicating whether the UE 115-a satisfies the TAT relaxation criteria.

The UE 115-a may determine whether the UE 115-a satisfies the TAT relaxation criteria. For example, if one or more of the TATs at the UE 115-a has accurate timing information based on a reference signal measurement, or the timing information of the TAT is within a threshold indicated by the TAT relaxation criteria, the UE 115-a may determine that the TAT satisfies the TAT relaxation criteria. For example, the UE 115-a may be a low mobility UE 115, and the timing information at the UE 115 may infrequently change or be inaccurate. Therefore, the TATs at the UE-a 115 may have accurate timing information which may satisfy the TAT relaxation criteria, and the TAT requirements or measurements may be relaxed, eased, or reduced.

In some examples, the UE 115-a may transmit a request 220 for TAT relaxation for one or more TATs. For example, the UE 115-a may transmit the request 220 including one or more identifiers for one or more TATs or identifiers for one or more timing advance groups, requesting for requirements or measurements for the TATs or timing advance groups to be relaxed. In some cases, the UE 115-a may request for TATs (or timing advance groups which correspond to the TATs) which satisfy the criteria to be relaxed.

Additionally, or alternatively, the UE 115-a may transmit a status report indicating whether the UE 115-a satisfies the TAT relaxation criteria. For example, the UE 115-a may indicate that one or more timing advance groups or TATs satisfy the TAT relaxation criteria (e.g., with or without a request 220 for TAT relaxation). If the UE 115-a at least partially does not satisfy the TAT relaxation criteria, the UE 115 may indicate that the UE 115-a does not at least partially satisfy the TAT relaxation criteria. For example, the UE 115-a may indicate that one or more timing advance groups or TATs do not satisfy the TAT relaxation criteria. In some cases, the UE 115-a may indicate a status of satisfying the TAT relaxation criteria for one or more uplink channels or uplink signals, or both, in a timing advance group. In some cases, the UE 115 may indicate that some timing advance groups, TATs, uplink channels, or uplink signals do satisfy the TAT relaxation criteria and some other timing advance groups, TATs, uplink channels, or uplink signals do not satisfy the TAT relaxation criteria.

The UE 115-a may transmit the TAT relaxation request or status report, or both, via one or more different messages. For example, the UE 115-a may transmit the TAT relaxation request or status report, or both, via a random access message, a configured grant message, a small data transmission, a periodic, semi-persistent, or aperiodic CSI report, a scheduling request, a MAC control message, a UE assistance information message, a UE capability message, or any combination thereof. In some cases, if the request 220 or status report are transmitted via the MAC control message, the MAC control message may include a dedicated MAC header.

The network entity 105-a may receive the request 220 and transmit an indication 210 of TAT relaxation parameters to the UE 115-a in response. The TAT relaxation parameters may ease or relax TAT requirements or measurements for one or more indicated TATs, timing advance groups, uplink channels, uplink signals, component carriers, or any combination thereof. In some cases, the TAT relaxation parameters may include one or more identifiers for one or more TATs or timing advance groups, or both. In some cases, the TAT relaxation parameters may include a duration of a time window for TAT relaxation associated with one or multiple TAT identifiers. In some cases, the indication 205 of the TAT relaxation criteria or the indication 210 of the TAT relaxation parameters may be transmitted via downlink control information, a MAC message (e.g., a MAC CE), RRC signaling, a multicast message or a broadcast message, or any combination thereof.

The UE 115-a may apply TAT relaxation for the one or more indicated TATs, timing advance groups, uplink channels or signals, or component carriers. The UE 115-a may transmit uplink signaling with relaxed or reduced measurements or TAT requirements in accordance with the TAT relaxation parameters. For example, the UE 115-a may send relaxed transmissions 225 based on applying the TAT relaxation parameters. For example, the UE 115-a may perform fewer or more infrequent measurements to check whether timing information is accurate to transmit the relaxed transmissions 225. The relaxed transmissions 225 may include, for example, uplink reference signals, uplink data messages, uplink control message, or any combination thereof. An uplink reference signal transmitted with the relaxed TAT restrictions may be, for example, a sounding reference signals (SRS) or a random access channel reference signals.

In some examples, the UE 115-a may apply the TAT relaxation parameters during a TAT relaxation window. In some cases, the TAT relaxation window may begin with a last symbol or slot of a downlink control channel message or downlink shared channel message associated with a TAT relaxation indication or upon receipt of the TAT relaxation parameters. In some cases, the UE 115-a may receive higher layer signaling (e.g., RRC signaling) indicating a cell-specific or UE-specific time offset with respect to a last symbol or last slot of receiving the indication for the TAT relaxation parameters.

In some examples, the UE 115-a may receive an indication of when to start applying the TAT relaxation parameters. For example, the UE 115-a may begin to apply the TAT relaxation parameters at a slot or symbol indicated by the network entity 105-a via downlink control information, a MAC message (e.g., a MAC CE), system information, or RRC signaling, or any combination thereof. In some examples, the indication 210 of the TAT relaxation parameters may include the indication of when to start applying the TAT relaxation parameters. Additionally, or alternatively, the indication of when to start applying the TAT relaxation parameters may be included in separate signaling.

In some examples, the UE 115-a may drop the request 220 or the status report, or both. For example, the UE 115-a may be scheduled for a higher priority uplink transmission (e.g., an uplink data or control message with a higher priority than a transmission including the request 220 or the status report) at a same time as the request 220 or the status report. For example, there may be a collision between the request 220 or the status report and other signaling. The collision may occur when the UE 115-a is operating according to a half-duplex configuration or a full-duplex configuration. The UE 115-a may drop the request 220 or the status report based on the scheduling conflict with the higher priority transmission. Additionally, or alternatively, the UE 115-a may be scheduled for a downlink transmission on an at least partially overlapping resources that are scheduled for the request 220 or the status report. In some cases, the UE 115-a may monitor for the downlink transmission instead of transmitting the request 220 or the status report. In some cases, the UE 115-a may retransmit the request 220 or the status report based on the initial transmission occurring during or colliding with a link adaptation procedure, a power control procedure, a coverage enhancement procedure (e.g., including repetitions, demodulation reference signal (DMRS) bundling, cycling of redundancy versions, frequency hopping, or any combination thereof), a transmit beam switching procedure, a bandwidth part switching procedure, an uplink carrier switching procedure, or any combination thereof.

The UE 115-a may retransmit the request 220 or the status report. In some cases, scheduling information or a resource configuration for a retransmission of the request 220 or the status report may be included with the TAT relaxation criteria. In some cases, the UE 115-a may send the retransmission if there is a valid transmit occasion for a random access channel message, an uplink shared channel message, or an uplink control channel message.

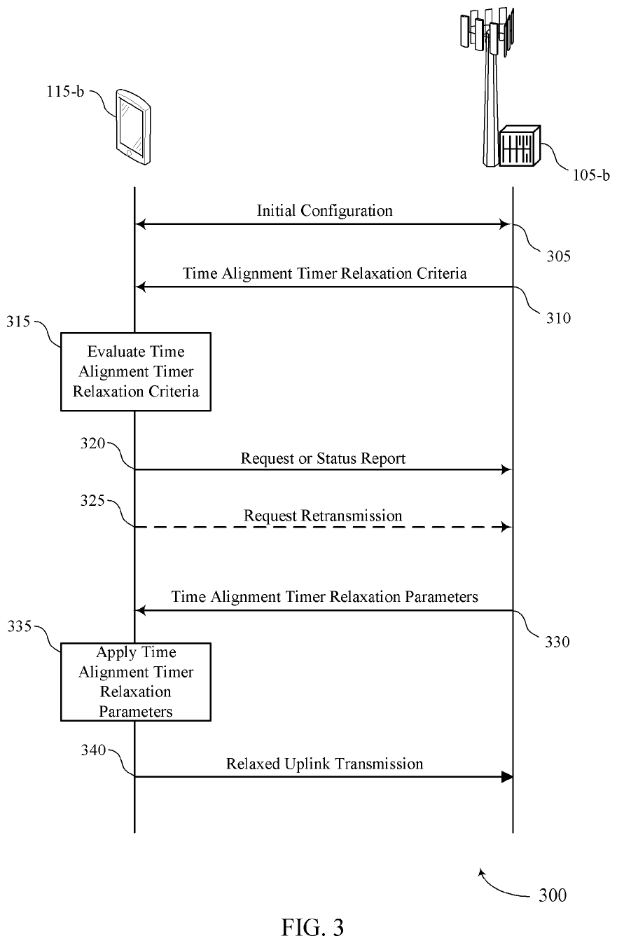

FIG. 3 illustrates an example of a process flow 300 that supports relaxation of TAT parameters in accordance with one or more aspects of the present disclosure. The process flow 300 may be implemented by a network entity 105-b or a UE 115-b, or both, which may be respective examples of a network entity 105-a and a UE 115-a as described herein with respect to FIG. 2. In some examples, some signaling or procedure of the process flow 300 may occur in different orders than shown. Additionally or alternatively, some additional procedures of signaling may occur, or some signaling or procedures may not occur.

At 305, the network entity 105-b and the UE 115-b may perform initial configuration communications. For example, the initial configuration communications may include a RACH procedure, such as a two step or a four step RACH procedure for small data transmission. Additionally or alternatively, the initial configuration communications may include a configuration of a configured grant resource for the UE 115-b. In some examples, the UE 115-b may perform small data transmission (e.g., communicate with the network entity 105-b in an idle or inactive state), and may notify the network entity 105-b during the initial configuration communications as described herein with reference to FIG. 1. In some cases, the UE 115-a may send an early indication of capabilities or features of the UE 115-a, such as indicating that the UE 115-a supports coverage enhancement, small data transmission, network slicing, TAT relaxation, or any combination thereof.

At 310, the network entity 105-b may transmit, to the UE 115-b, an indication of TAT relaxation criteria. In some cases, the indication of TAT relaxation criteria may include an indication of one or more reference signal types, one or more measurement thresholds, one or more filtering coefficients, one or more evaluation metrics, or any combination thereof, for a reference signal measurement to satisfy the TAT relaxation criteria. For example, the TAT relaxation criteria may indicate one or more timing advance groups and one or more reference signals types associated with a timing advance group of the one or more timing advance groups.

In some cases, the indication of the time alignment relaxation criteria may indicate a resource configuration and scheduling information for transmission, retransmission, or both, of a request or status report for TAT relaxation. In some examples, the network entity 105-b may configure criteria for TAT relaxation and signal the criteria, to at least the UE 115-b, via a system information message, via a RRC message, or via a multicast or broadcast message. The network entity 105-b may jointly configure the criteria for TAT relaxation with a measurement relaxation criteria for radio resource management (RRM), radio link monitoring (RLM), or beam failure detection. Additionally or alternatively, the network entity 105-b may configure the criteria for TAT relaxation separately. In some cases, the TAT relaxation criteria may indicate respective criteria for a timing advance group, one or more TATs, one or more uplink signals, one or more uplink channels, or any combination thereof.

At 315, the UE 115-b may evaluate the time alignment relaxation criteria received from the network entity 105-b. In some cases, the UE 115-b may measure one or more reference signals and compare the measurements to the TAT relaxation criteria in order to determine relaxation eligibility. For example, the UE 115-b may measure reference signals of an indicated type that are associated with a timing advance group. The UE 115-b may compare measurements of the reference signals to one or more thresholds of the TAT relaxation criteria and determine whether the measurements or timing information of the UE 115-b satisfy the TAT relaxation criteria or the indicated metrics. If, for example, measurements for reference signals associated with a timing advance group satisfy the criteria (e.g., satisfy a threshold or correspond to accurate timing information), the UE 115-b may determine that uplink signaling or uplink channels associated with the timing advance group are eligible for TAT relaxation.

At 320, the UE 115-b may transmit, to the network entity 105-b, a request for TAT relaxation based on determining eligibility for TAT relaxation. For example, the UE 115-b may determine (e.g., via one or more reference signal measurements) that one or more TATs or time alignment groups satisfy the criteria for TAT relaxation, and may request TAT relaxation for the one or more TATs or time alignment groups, one or more uplink signals, one or more uplink channels, or any combination thereof. In some cases, the UE 115-b may transmit the request for TAT relaxation via a random access message, a configured grant transmission, a small data transmission, a periodic, semi-persistent, or aperiodic CSI report, a scheduling request, a MAC CE with a dedicated MAC header, uplink control information, a UE assistance information message, a UE capability message, or any combination thereof.

In some cases, at 320, the UE 115-b may transmit, to the network entity 105-b, a status report indicating whether or not the TAT criteria has be satisfied. For example, the UE 115-b may indicate that one or more uplink signals or uplink channels in a timing advance group satisfy the criteria for TAT relaxation in the status report. Additionally or alternatively, the status report may indicate that the one or more uplink signals or uplink channels in a timing advance group do not satisfy the criteria for TAT relaxation, and the UE 115-b may refrain from transmitting a request for time alignment relaxation. In some examples, the UE 115-b may multiplex the status report for multiple timing advance groups in a single transmission.

At 325, the UE 115-b may optionally retransmit the request for TAT relaxation or status report. For example, the UE 115-b may drop a transmission occasion for the TAT relaxation request due to identifying a collision with another transmission (e.g., a collision with a downlink reception, a collision with other uplink transmissions having higher priority, or both). In some cases, the collisions may occur when the UE 115-b operates according to a full-duplex or a half-duplex mode. Additionally or alternatively, the UE 115-b may determine to retransmit the request for TAT relaxation or status report due to not receiving a response from the network entity 105-b. The UE 115-b may then, based on dropping the transmission occasion, retransmit the request for TAT relaxation or status report. In some examples, the retransmission of the request or the status report may be based on a link adaptation procedure, a coverage enhancement procedure (e.g., repetitions, demodulated reference signal bundling, cycling of redundance versions, or frequency hopping), a transmit beam switching procedure, a bandwidth part switching procedure, an uplink carrier switching procedure, or any combination thereof.

At 330, the network entity 105-b may transmit, to the UE 115-b, TAT relaxation parameters based on the request for TAT relaxation or the UE 115-b status report. In some cases, the TAT relaxation parameters may include an indication of one or more timing advance groups, one or more TATs, one or more TAT identifiers, one or more uplink signals, one or more uplink channels, or any combination thereof, enabled for TAT relaxation. The TAT relaxation parameters may further indicate, to the UE 115-b, a time window duration for applying the TAT relaxation in accordance with the TAT relaxation parameters, a configuration for reduced monitoring occasions for downlink control channel within the time window, a configuration of extended discontinuous reception within the time window, or any combination thereof.

Additionally or alternatively, the network entity 105-b may transmit, via the TAT relaxation parameters, control signaling configuring a set of reference signal resources (e.g., a cell-defining synchronization signal block (SSB), a non cell-defining SSB, a channel state information reference signal, a tracking reference signal, a positioning reference signal, a re-synchronization signal, a wake-up signal, or any combination thereof) for measurements associated with TAT management, RRM, RLM, beam management, beam failure detection, link adaptation, power control, or any combination thereof. In some cases, the network entity may indicate the TAT relaxation parameters, the time alignment relaxation criteria, or both, via a downlink control information, a MAC CE, RRC signaling, a multicast message, a broadcast message, or any combination thereof.

At 335, the UE 115-b may apply the TAT relaxation parameters based on receiving the parameters and the indicated time window. For example, the UE 115-b may identify one or more TATs or time alignment groups to be relaxed, and may apply the relaxation parameters to the one or more TATs or time alignment groups. In some cases, the UE 115-b may apply the relaxation parameters after a last symbol or a lost slot of a downlink channel carrying the indication of the TAT relaxation parameters. The UE 115-b may receive higher layer signaling (e.g., via a RRC message) indicating a cell-specific or UE-specific time offset with respect to the last symbol or last slot of receiving the indication for the TAT relaxation parameters. Additionally or alternatively, the UE 115-b may receive a start time to apply the TAT relaxation parameters via a downlink control information, a MAC CE, a system information message, radio resource control signaling, or any combination thereof.

At 340, the UE 115-b may transmit one or more signals in accordance with the TAT relaxation parameters. For example, the UE 115-b may transmit one or more uplink reference signals, data transmissions, or control messages in accordance with the applied TAT relaxation parameters.

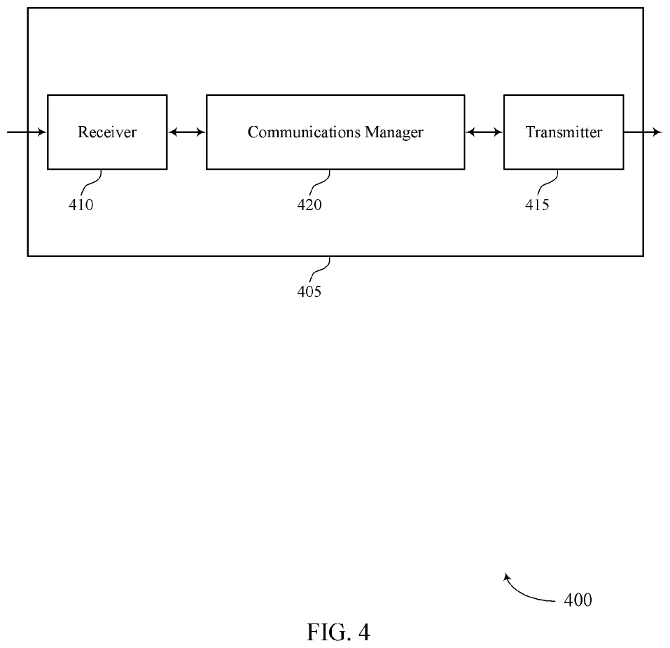

FIG. 4 shows a block diagram 400 of a device 405 that supports relaxation of TAT parameters in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to relaxation of TAT parameters). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to relaxation of TAT parameters). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of relaxation of TAT parameters as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, a graphics processing unit (GPU), an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving an indication of TAT relaxation criteria for one or more TATs at the UE. The communications manager 420 may be configured as or otherwise support a means for transmitting a request or a status report for TAT relaxation based on satisfying the TAT relaxation criteria. The communications manager 420 may be configured as or otherwise support a means for receiving an indication of TAT relaxation parameters in response to the request or status report.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced power consumption at the device 705, by reducing reference signal measurements, measurement reporting, and monitoring.

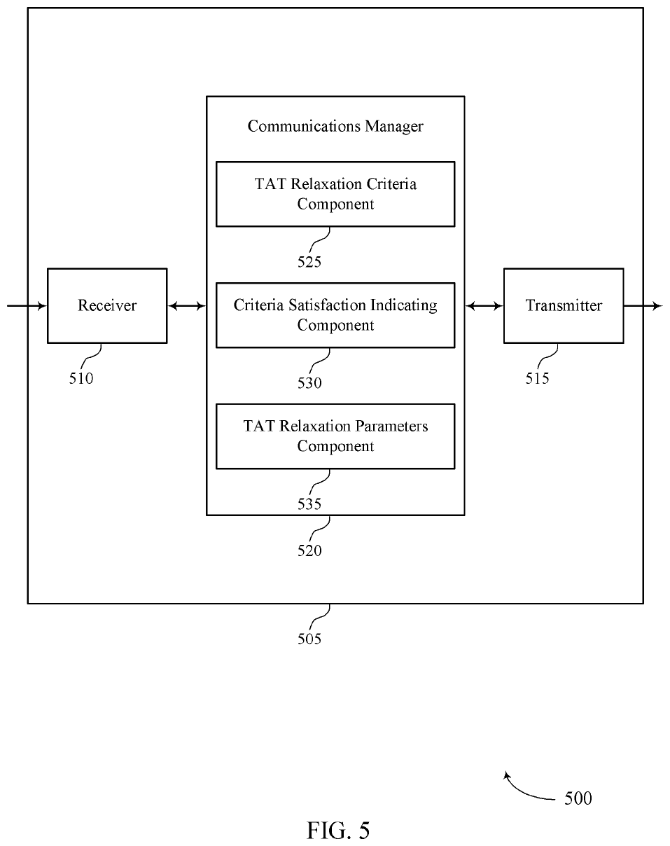

FIG. 5 shows a block diagram 500 of a device 505 that supports relaxation of TAT parameters in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to relaxation of TAT parameters). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to relaxation of TAT parameters). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of relaxation of TAT parameters as described herein. For example, the communications manager 520 may include a TAT relaxation criteria component 525, a criteria satisfaction indicating component 530, a TAT relaxation parameters component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The TAT relaxation criteria component 525 may be configured as or otherwise support a means for receiving an indication of TAT relaxation criteria for one or more TATs at the UE. The criteria satisfaction indicating component 530 may be configured as or otherwise support a means for transmitting a request or a status report for TAT relaxation based on satisfying the TAT relaxation criteria. The TAT relaxation parameters component 535 may be configured as or otherwise support a means for receiving an indication of TAT relaxation parameters in response to the request or status report.

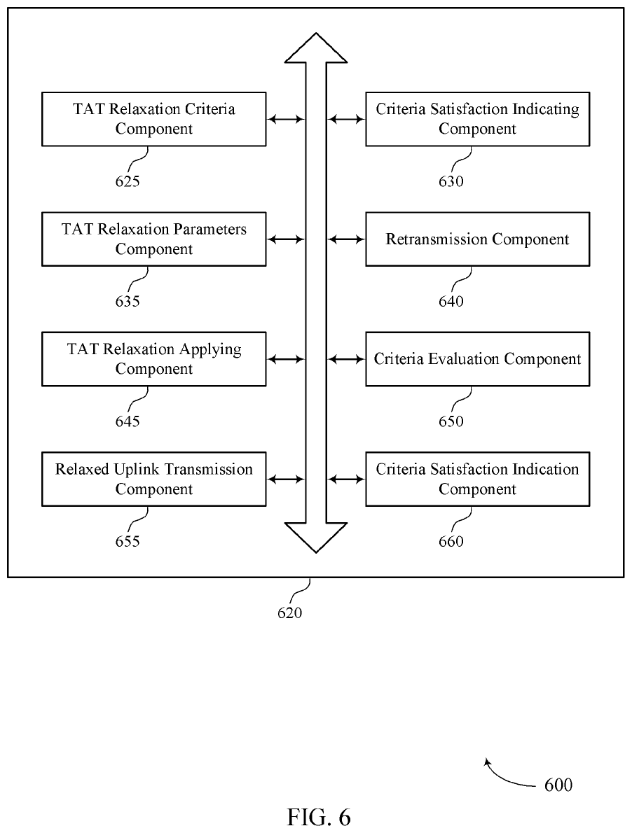

FIG. 6 shows a block diagram 600 of a communications manager 620 that supports relaxation of TAT parameters in accordance with one or more aspects of the present disclosure. The communications manager 620 may be an example of aspects of a communications manager 420, a communications manager 520, or both, as described herein. The communications manager 620, or various components thereof, may be an example of means for performing various aspects of relaxation of TAT parameters as described herein. For example, the communications manager 620 may include a TAT relaxation criteria component 625, a criteria satisfaction indicating component 630, a TAT relaxation parameters component 635, a retransmission component 640, a TAT relaxation applying component 645, a criteria evaluation component 650, a relaxed uplink transmission component 655, a criteria satisfaction indication component 660, or any combination thereof. Each of these components may communicate, directly or indirectly, with one another (e.g., via one or more buses).

The communications manager 620 may support wireless communications at a UE in accordance with examples as disclosed herein. The TAT relaxation criteria component 625 may be configured as or otherwise support a means for receiving an indication of TAT relaxation criteria for one or more TATs at the UE. The criteria satisfaction indicating component 630 may be configured as or otherwise support a means for transmitting a request or a status report for TAT relaxation based on satisfying the TAT relaxation criteria. The TAT relaxation parameters component 635 may be configured as or otherwise support a means for receiving an indication of TAT relaxation parameters in response to the request or status report.

In some examples, to support receiving the indication of the TAT relaxation criteria, the TAT relaxation criteria component 625 may be configured as or otherwise support a means for receiving an indication of one or more timing advance groups, an indication of one or more reference signal types associated with a timing advance group of the one or more timing advance groups, one or more measurement thresholds, one or more filtering coefficients, one or more evaluation metrics, or any combination thereof, for a reference signal measurement to satisfy the TAT relaxation criteria, where the indication of the TAT relaxation criteria further indicates a resource configuration and scheduling information for transmission or retransmission, or both, of the request or the status report for TAT relaxation.

In some examples, to support receiving the indication of the TAT relaxation criteria, the TAT relaxation criteria component 625 may be configured as or otherwise support a means for receiving the indication of the TAT relaxation criteria for a timing advance group, one or more TATs, one or more uplink signals, one or more uplink channels, or any combination thereof.

In some examples, to support transmitting the status report, the criteria satisfaction indicating component 630 may be configured as or otherwise support a means for transmitting the status report indicating that a status of the UE satisfies the TAT relaxation criteria for one or more uplink signals or uplink channels in a timing advance group. In some examples, to support transmitting the status report, the criteria satisfaction indicating component 630 may be configured as or otherwise support a means for requesting for the TAT relaxation for the one or more uplink signals or uplink channels in the timing advance group.

In some examples, to support transmitting the request, the criteria satisfaction indicating component 630 may be configured as or otherwise support a means for requesting for TAT relaxation for a timing advance group, one or more TATs, one or more uplink signals, one or more uplink channels, or any combination thereof.

In some examples, to support transmitting the request or the status report, the criteria satisfaction indicating component 630 may be configured as or otherwise support a means for transmitting the request or the status report via a random access message, a configured grant transmission, a small data transmission, a periodic, semi-persistent, or aperiodic channel state information report, a scheduling request, a MAC control message with a dedicated MAC header, an uplink control information message, a UE assistance information message, or a UE capability message, or any combination thereof.

In some examples, the retransmission component 640 may be configured as or otherwise support a means for transmitting a retransmission of the request or the status report for TAT relaxation based on not receiving a response to the request or based on a collision with downlink channels or higher priority uplink signaling.

In some examples, the retransmission of the request or the status report is based on a link adaptation procedure, a random back-off procedure, a power control procedure, a coverage enhancement procedure, a transmit beam switching procedure, a bandwidth part switching procedure, an uplink carrier switching procedure, or any combination thereof.

In some examples, to support receiving the indication of the TAT relaxation parameters, the TAT relaxation parameters component 635 may be configured as or otherwise support a means for receiving an indication of one or more timing advance groups, one or more TATs, one or more TAT identifiers, one or more uplink signals, one or more uplink channels, or any combination thereof, enabled for TAT relaxation.

In some examples, to support receiving the indication of the TAT relaxation parameters, the TAT relaxation parameters component 635 may be configured as or otherwise support a means for receiving an indication of a time window duration for applying the TAT relaxation, a configuration for reduced monitoring occasions for downlink control channel within the time window, a configuration of extended discontinuous reception within the time window, or any combination thereof.

In some examples, to support receiving the indication of the TAT relaxation parameters, the TAT relaxation parameters component 635 may be configured as or otherwise support a means for receiving control signaling configuring a set of reference signal resources for measurements associated with TAT management, RRM, RLM, beam management, beam failure detection, link adaptation, power control, or any combination thereof.

In some examples, the TAT relaxation applying component 645 may be configured as or otherwise support a means for applying the TAT relaxation parameters starting no earlier than a last symbol or a last slot of a downlink channel carrying the indication of the TAT relaxation parameters, where a cell-specific or UE-specific time offset with respect to the last symbol or last slot of receiving the indication for TAT relaxation parameters is received via higher layer signaling.

In some examples, the TAT relaxation applying component 645 may be configured as or otherwise support a means for receiving an indication of a start time to apply the TAT relaxation parameters via downlink control information, a MAC control element, system information, or radio resource control signaling, or any combination thereof.

In some examples, the criteria evaluation component 650 may be configured as or otherwise support a means for measuring one or more reference signals to obtain one or more reference signal measurements. In some examples, the criteria evaluation component 650 may be configured as or otherwise support a means for determining that the TAT relaxation criteria is satisfied based on the one or more reference signal measurements, a capability of the UE, and thresholds for the one or more reference signal measurements.

In some examples, the relaxed uplink transmission component 655 may be configured as or otherwise support a means for transmitting one or more uplink reference signals, data or control messages in accordance with the TAT relaxation parameters.

In some examples, to support receiving the indication of the TAT relaxation parameters, the TAT relaxation parameters component 635 may be configured as or otherwise support a means for receiving an indication of the TAT relaxation criteria with relaxation criteria for RRM, RLM, beam management, beam failure detection, or any combination thereof.

In some examples, to support transmitting the request or the status report, the criteria satisfaction indicating component 630 may be configured as or otherwise support a means for transmitting the request or the status report while operating in an idle state, an inactive state, or a connected state.

In some examples, the indication of the TAT relaxation criteria or the indication of the TAT relaxation parameters, or both, is received via downlink control information, a MAC control element, radio resource control signaling, a multicast message, or a broadcast message, or any combination thereof.

In some examples, to support transmitting the status report, the criteria satisfaction indication component 660 may be configured as or otherwise support a means for transmitting the request or the status report for multiple timing advance groups multiplexed in a single transmission of UE.

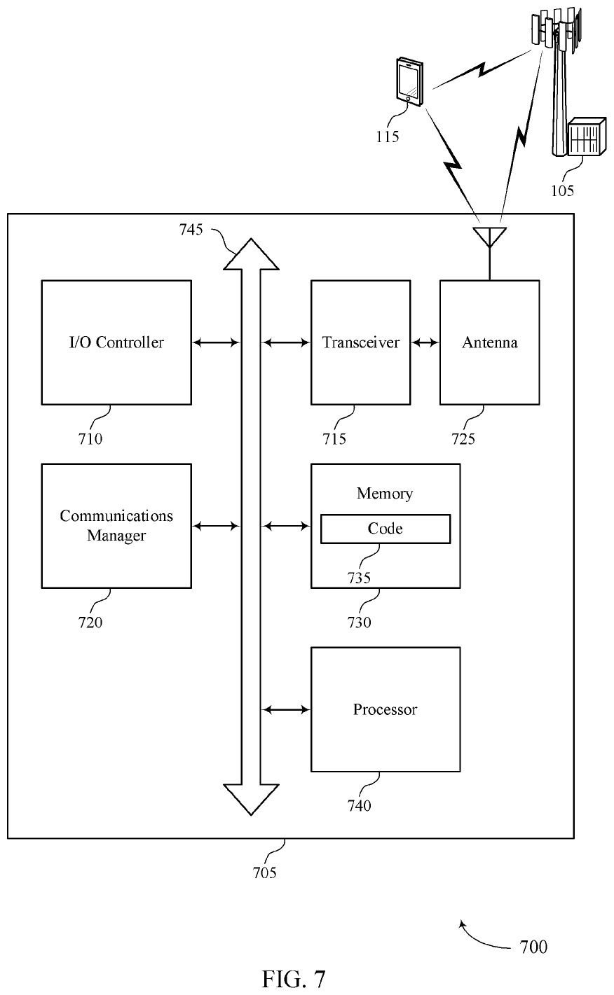

FIG. 7 shows a diagram of a system 700 including a device 705 that supports relaxation of TAT parameters in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®), or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting relaxation of TAT parameters). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving an indication of TAT relaxation criteria for one or more TATs at the UE. The communications manager 720 may be configured as or otherwise support a means for transmitting a request or a status report for TAT relaxation based on satisfying the TAT relaxation criteria. The communications manager 720 may be configured as or otherwise support a means for receiving an indication of TAT relaxation parameters in response to the request or status report.

By including or configuring the communications manager 720 in accordance with examples as described herein, the device 705 may support techniques for reduced power consumption at the device 705, by reducing reference signal measurements, measurement reporting, and monitoring.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of relaxation of TAT parameters as described herein, or the processor 740 and the memory 730 may be otherwise configured to perform or support such operations.

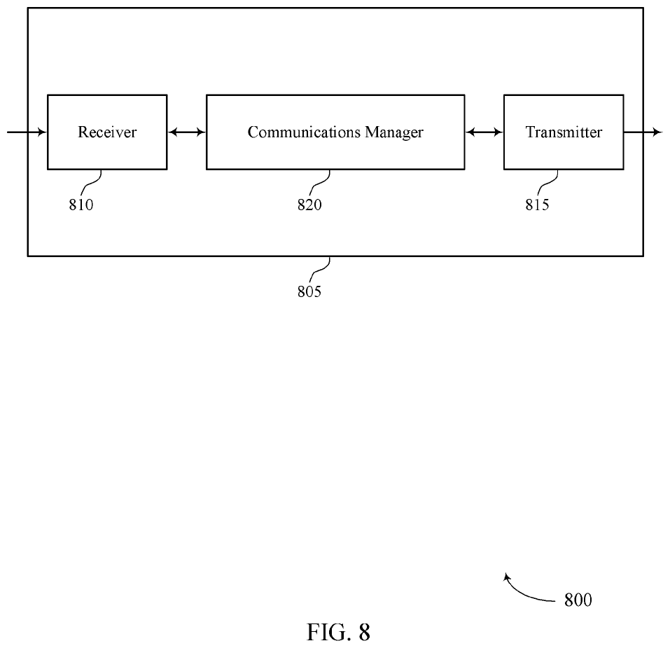

FIG. 8 shows a block diagram 800 of a device 805 that supports relaxation of TAT parameters in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of relaxation of TAT parameters as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for transmitting an indication of TAT relaxation criteria for one or more TATs at a UE. The communications manager 820 may be configured as or otherwise support a means for receiving a request or a status report for TAT relaxation based on satisfying the TAT relaxation criteria. The communications manager 820 may be configured as or otherwise support a means for transmitting an indication of TAT relaxation parameters in response to the request.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reducing signaling overhead, by reducing timing advance transmissions, and reducing complexity, based on processing fewer measurement reports and uplink signals.

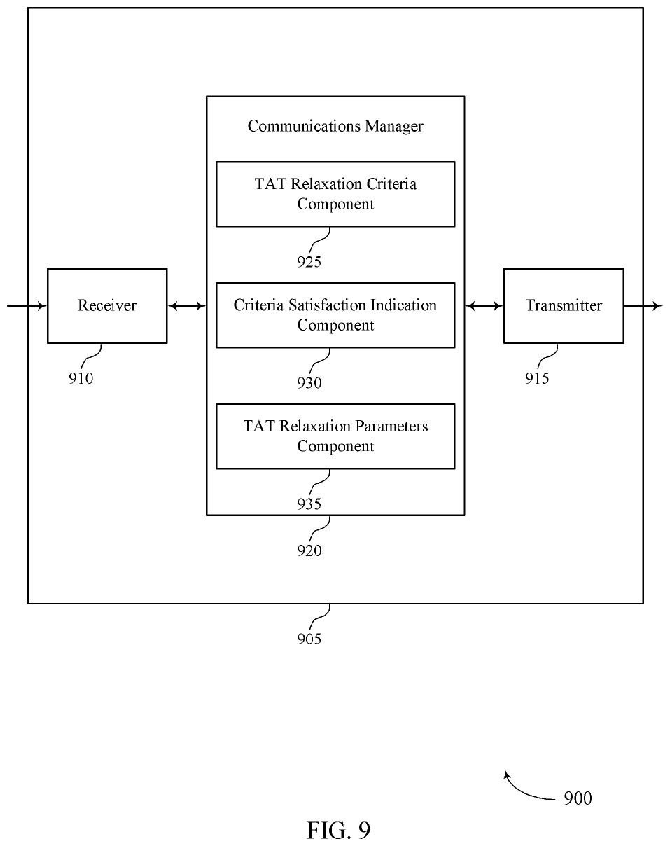

FIG. 9 shows a block diagram 900 of a device 905 that supports relaxation of TAT parameters in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of relaxation of TAT parameters as described herein. For example, the communications manager 920 may include a TAT relaxation criteria component 925, a criteria satisfaction indication component 930, a TAT relaxation parameters component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The TAT relaxation criteria component 925 may be configured as or otherwise support a means for transmitting an indication of TAT relaxation criteria for one or more TATs at a UE. The criteria satisfaction indication component 930 may be configured as or otherwise support a means for receiving a request or a status report for TAT relaxation based on satisfying the TAT relaxation criteria. The TAT relaxation parameters component 935 may be configured as or otherwise support a means for transmitting an indication of TAT relaxation parameters in response to the request.

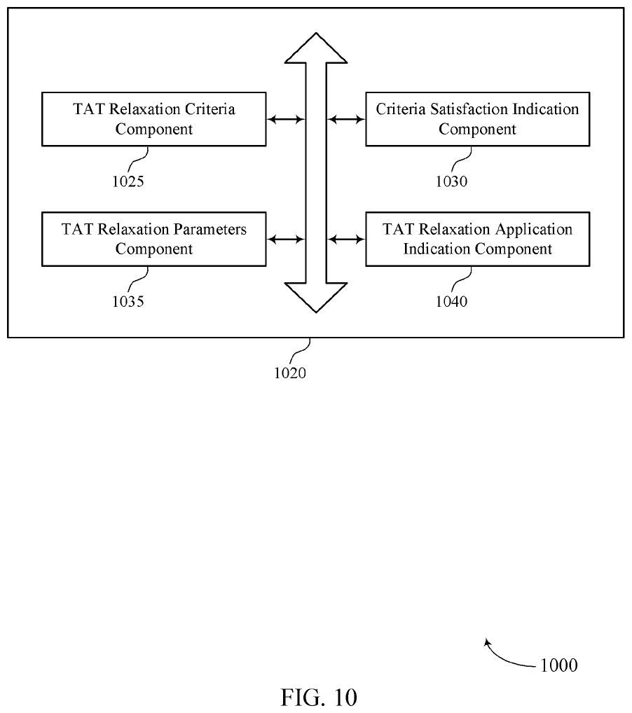

FIG. 10 shows a block diagram 1000 of a communications manager 1020 that supports relaxation of TAT parameters in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of relaxation of TAT parameters as described herein. For example, the communications manager 1020 may include a TAT relaxation criteria component 1025, a criteria satisfaction indication component 1030, a TAT relaxation parameters component 1035, a TAT relaxation application indication component 1040, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The TAT relaxation criteria component 1025 may be configured as or otherwise support a means for transmitting an indication of TAT relaxation criteria for one or more TATs at a UE. The criteria satisfaction indication component 1030 may be configured as or otherwise support a means for receiving a request or a status report for TAT relaxation based on satisfying the TAT relaxation criteria. The TAT relaxation parameters component 1035 may be configured as or otherwise support a means for transmitting an indication of TAT relaxation parameters in response to the request.

In some examples, to support transmitting the indication of the TAT relaxation criteria, the TAT relaxation criteria component 1025 may be configured as or otherwise support a means for transmitting an indication of one or more timing advance groups, one or more reference signal types associated with a timing advance group of the one or more timing advance groups, one or more measurement thresholds, one or more filtering coefficients, one or more evaluation metrics, or any combination thereof, for a reference signal measurement to satisfy the TAT relaxation criteria, where the indication of the TAT relaxation criteria further indicates a resource configuration and scheduling information for transmission or retransmission, or both, of the request or the status report for TAT relaxation.

In some examples, to support transmitting the indication of the TAT relaxation criteria, the TAT relaxation criteria component 1025 may be configured as or otherwise support a means for transmitting the indication of the TAT relaxation criteria for a timing advance group, one or more TATs, one or more uplink signals, one or more uplink channels, or any combination thereof.

In some examples, to support receiving the request, the criteria satisfaction indication component 1030 may be configured as or otherwise support a means for receiving the request for TAT relaxation for a timing advance group, one or more TATs, one or more uplink signals, one or more uplink channels, or any combination thereof.

In some examples, to support receiving the status report or the request, the criteria satisfaction indication component 1030 may be configured as or otherwise support a means for receiving the status report indicating that a status of the UE satisfies the TAT relaxation criteria for one or more uplink signals or uplink channels in a timing advance group. In some examples, to support receiving the status report or the request, the criteria satisfaction indication component 1030 may be configured as or otherwise support a means for receiving the request for the TAT relaxation for the one or more uplink signals or uplink channels in the timing advance group.

In some examples, to support receiving the request or the status report, the criteria satisfaction indication component 1030 may be configured as or otherwise support a means for receiving the request or the status report via a random access message, a configured grant transmission, a small data transmission, a periodic, semi-persistent, or aperiodic channel state information report, a scheduling request, a MAC control message with a dedicated MAC header, an uplink control information message, a UE assistance information message, or a UE capability message, or any combination thereof.

In some examples, to support transmitting the indication of the TAT relaxation parameters, the TAT relaxation parameters component 1035 may be configured as or otherwise support a means for transmitting an indication of one or more timing advance groups, one or more TATs, one or more TAT identifiers, one or more uplink signals, one or more uplink channels, or any combination thereof, enabled for TAT relaxation.

In some examples, to support transmitting the indication of the TAT relaxation parameters, the TAT relaxation parameters component 1035 may be configured as or otherwise support a means for transmitting an indication of a time window duration for applying the TAT relaxation, a configuration for reduced monitoring occasions for downlink control channel within the time window, a configuration of extended discontinuous reception within the time window, or any combination thereof.

In some examples, to support transmitting the indication of the TAT relaxation parameters, the TAT relaxation parameters component 1035 may be configured as or otherwise support a means for transmitting control signaling configuring a set of reference signal resources for measurements associated with TAT management, RRM, RLM, beam management, beam failure detection, link adaptation, power control, or any combination thereof.

In some examples, the TAT relaxation application indication component 1040 may be configured as or otherwise support a means for transmitting an indication of a start time to apply the TAT relaxation parameters via downlink control information, a MAC control element, system information, or radio resource control signaling, or any combination thereof.

In some examples, to support transmitting the indication of the TAT relaxation parameters, the TAT relaxation parameters component 1035 may be configured as or otherwise support a means for transmitting an indication of the TAT relaxation criteria with relaxation criteria for RRM, RLM, beam management, beam failure detection, or any combination thereof.

In some examples, to support receiving the request or the status report, the criteria satisfaction indication component 1030 may be configured as or otherwise support a means for receiving the request from a UE operating in an idle state, an inactive state, or a connected state.

In some examples, the indication of the TAT relaxation criteria or the indication of the TAT relaxation parameters, or both, is transmitted via downlink control information, a MAC control element, radio resource control signaling, a multicast message, or a broadcast message, or any combination thereof.

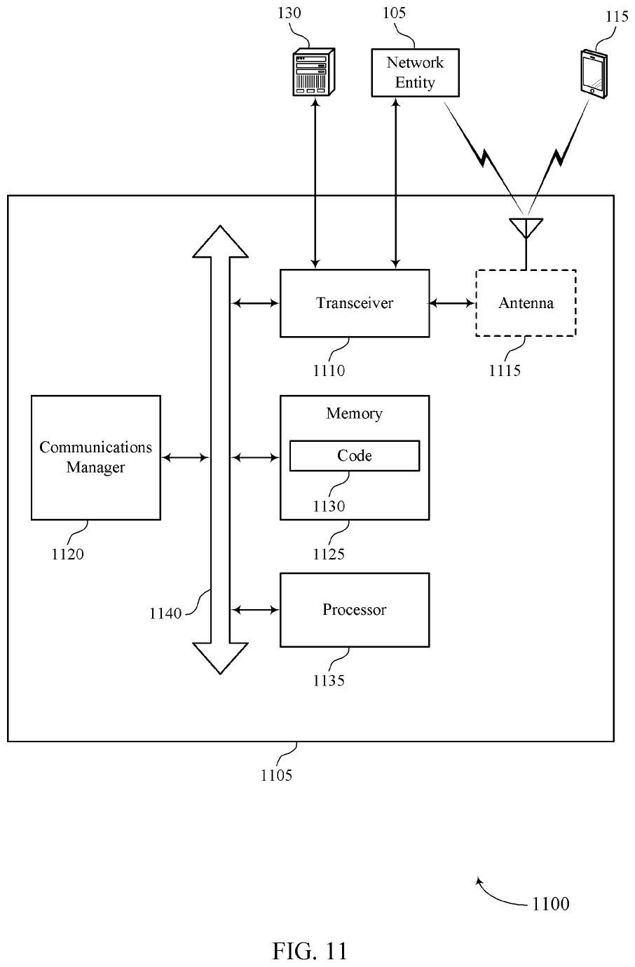

FIG. 11 shows a diagram of a system 1100 including a device 1105 that supports relaxation of TAT parameters in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting relaxation of TAT parameters). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for transmitting an indication of TAT relaxation criteria for one or more TATs at a UE. The communications manager 1120 may be configured as or otherwise support a means for receiving a request or a status report for TAT relaxation based on satisfying the TAT relaxation criteria. The communications manager 1120 may be configured as or otherwise support a means for transmitting an indication of TAT relaxation parameters in response to the request.

By including or configuring the communications manager 1120 in accordance with examples as described herein, the device 1105 may support techniques for reducing signaling overhead, by reducing timing advance transmissions, and reducing complexity, based on processing fewer measurement reports and uplink signals.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of relaxation of TAT parameters as described herein, or the processor 1135 and the memory 1125 may be otherwise configured to perform or support such operations.

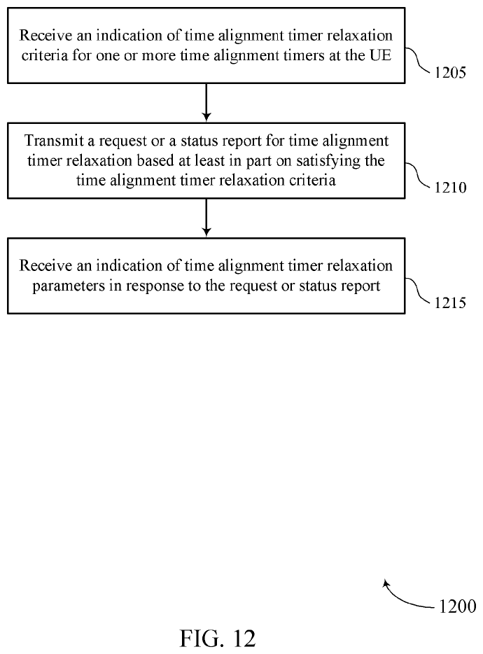

FIG. 12 shows a flowchart illustrating a method 1200 that supports relaxation of TAT parameters in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving an indication of TAT relaxation criteria for one or more TATs at the UE. The operations of 1205 may be performed in accordance with examples as disclosed herein. In some examples, aspects of the operations of 1205 may be performed by a TAT relaxation criteria component 625 as described with reference to FIG. 6.

At 1210, the method may include transmitting a request or a status report for TAT relaxation based on satisfying the TAT relaxation criteria. The operations of 1210 may be performed in accordance with examples as disclosed herein. In some examples, aspects of the operations of 1210 may be performed by a criteria satisfaction indicating component 630 as described with reference to FIG. 6.

At 1215, the method may include receiving an indication of TAT relaxation parameters in response to the request or status report. The operations of 1215 may be performed in accordance with examples as disclosed herein. In some examples, aspects of the operations of 1215 may be performed by a TAT relaxation parameters component 635 as described with reference to FIG. 6.

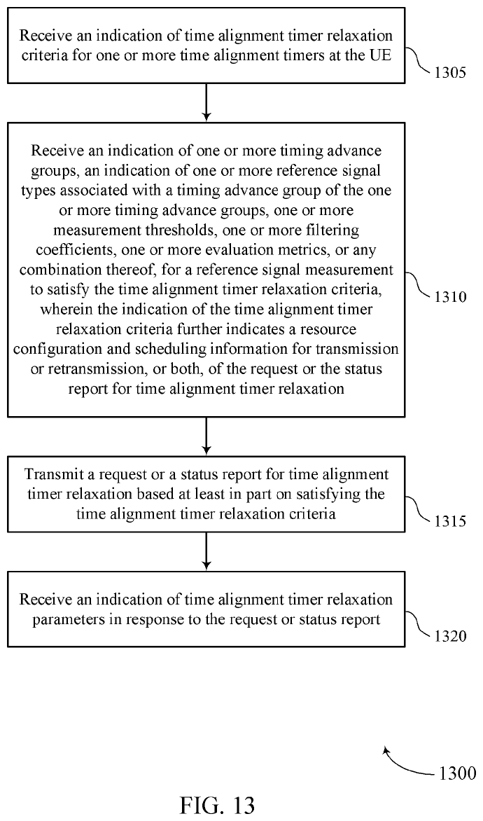

FIG. 13 shows a flowchart illustrating a method 1300 that supports relaxation of TAT parameters in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving an indication of TAT relaxation criteria for one or more TATs at the UE. The operations of 1305 may be performed in accordance with examples as disclosed herein. In some examples, aspects of the operations of 1305 may be performed by a TAT relaxation criteria component 625 as described with reference to FIG. 6.

At 1310, the method may include receiving an indication of one or more timing advance groups, an indication of one or more reference signal types associated with a timing advance group of the one or more timing advance groups, one or more measurement thresholds, one or more filtering coefficients, one or more evaluation metrics, or any combination thereof, for a reference signal measurement to satisfy the TAT relaxation criteria, where the indication of the TAT relaxation criteria further indicates a resource configuration and scheduling information for transmission or retransmission, or both, of the request or the status report for TAT relaxation. The operations of 1310 may be performed in accordance with examples as disclosed herein. In some examples, aspects of the operations of 1310 may be performed by a TAT relaxation criteria component 625 as described with reference to FIG. 6.

At 1315, the method may include transmitting a request or a status report for TAT relaxation based on satisfying the TAT relaxation criteria. The operations of 1315 may be performed in accordance with examples as disclosed herein. In some examples, aspects of the operations of 1315 may be performed by a criteria satisfaction indicating component 630 as described with reference to FIG. 6.

At 1320, the method may include receiving an indication of TAT relaxation parameters in response to the request or status report. The operations of 1320 may be performed in accordance with examples as disclosed herein. In some examples, aspects of the operations of 1320 may be performed by a TAT relaxation parameters component 635 as described with reference to FIG. 6.

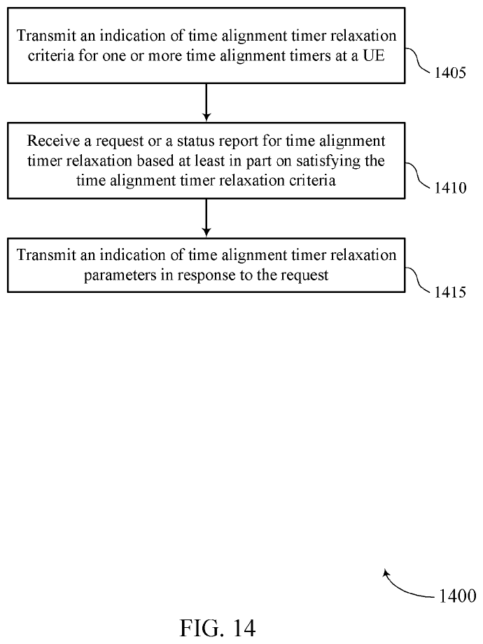

FIG. 14 shows a flowchart illustrating a method 1400 that supports relaxation of TAT parameters in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting an indication of TAT relaxation criteria for one or more TATs at a UE. The operations of 1405 may be performed in accordance with examples as disclosed herein. In some examples, aspects of the operations of 1405 may be performed by a TAT relaxation criteria component 1025 as described with reference to FIG. 10.

At 1410, the method may include receiving a request or a status report for TAT relaxation based on satisfying the TAT relaxation criteria. The operations of 1410 may be performed in accordance with examples as disclosed herein. In some examples, aspects of the operations of 1410 may be performed by a criteria satisfaction indication component 1030 as described with reference to FIG. 10.

At 1415, the method may include transmitting an indication of TAT relaxation parameters in response to the request. The operations of 1415 may be performed in accordance with examples as disclosed herein. In some examples, aspects of the operations of 1415 may be performed by a TAT relaxation parameters component 1035 as described with reference to FIG. 10.

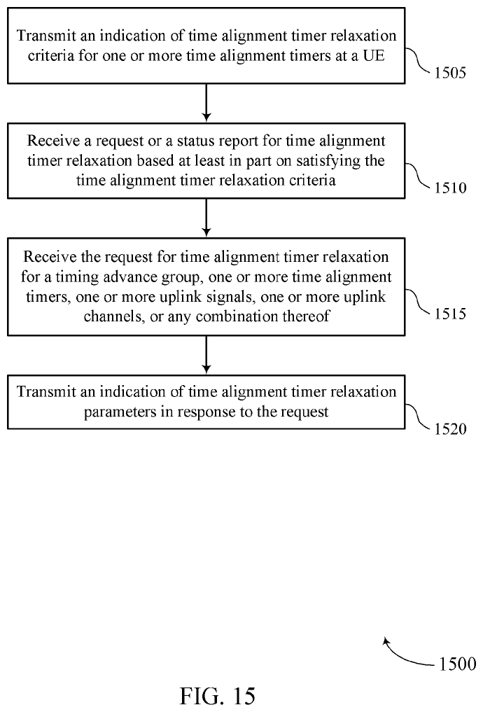

FIG. 15 shows a flowchart illustrating a method 1500 that supports relaxation of TAT parameters in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting an indication of TAT relaxation criteria for one or more TATs at a UE. The operations of 1505 may be performed in accordance with examples as disclosed herein. In some examples, aspects of the operations of 1505 may be performed by a TAT relaxation criteria component 1025 as described with reference to FIG. 10.

At 1510, the method may include receiving a request or a status report for TAT relaxation based on satisfying the TAT relaxation criteria. The operations of 1510 may be performed in accordance with examples as disclosed herein. In some examples, aspects of the operations of 1510 may be performed by a criteria satisfaction indication component 1030 as described with reference to FIG. 10.

At 1515, the method may include receiving the request for TAT relaxation for a timing advance group, one or more TATs, one or more uplink signals, one or more uplink channels, or any combination thereof. The operations of 1515 may be performed in accordance with examples as disclosed herein. In some examples, aspects of the operations of 1515 may be performed by a criteria satisfaction indication component 1030 as described with reference to FIG. 10.

At 1520, the method may include transmitting an indication of TAT relaxation parameters in response to the request. The operations of 1520 may be performed in accordance with examples as disclosed herein. In some examples, aspects of the operations of 1520 may be performed by a TAT relaxation parameters component 1035 as described with reference to FIG. 10.

The following provides an overview of aspects of the present disclosure:

Aspect 1: A method for wireless communications at a UE, comprising: receiving an indication of time alignment timer relaxation criteria for one or more time alignment timers at the UE; transmitting a request or a status report for time alignment timer relaxation based at least in part on satisfying the time alignment timer relaxation criteria; and receiving an indication of time alignment timer relaxation parameters in response to the request or status report.

Aspect 2: The method of aspect 1, wherein receiving the indication of the time alignment timer relaxation criteria comprises: receiving an indication of one or more timing advance groups, an indication of one or more reference signal types associated with a timing advance group of the one or more timing advance groups, one or more measurement thresholds, one or more filtering coefficients, one or more evaluation metrics, or any combination thereof, for a reference signal measurement to satisfy the time alignment timer relaxation criteria, wherein the indication of the time alignment timer relaxation criteria further indicates a resource configuration and scheduling information for transmission or retransmission, or both, of the request or the status report for time alignment timer relaxation.

Aspect 3: The method of any of aspects 1 through 2, wherein receiving the indication of the time alignment timer relaxation criteria comprises: receiving the indication of the time alignment timer relaxation criteria for a timing advance group, one or more time alignment timers, one or more uplink signals, one or more uplink channels, or any combination thereof.

Aspect 4: The method of any of aspects 1 through 3, wherein transmitting the status report comprises: transmitting the status report indicating that a status of the UE satisfies the time alignment timer relaxation criteria for one or more uplink signals or uplink channels in a timing advance group; and requesting for the time alignment timer relaxation for the one or more uplink signals or uplink channels in the timing advance group.

Aspect 5: The method of any of aspects 1 through 4, wherein transmitting the request comprises: requesting for time alignment timer relaxation for a timing advance group, one or more time alignment timers, one or more uplink signals, one or more uplink channels, or any combination thereof.

Aspect 6: The method of any of aspects 1 through 5, wherein transmitting the request or the status report comprises: transmitting the request or the status report via a random access message, a configured grant transmission, a small data transmission, a periodic, semi-persistent, or aperiodic channel state information report, a scheduling request, a medium access control (MAC) control message with a dedicated MAC header, an uplink control information message, a UE assistance information message, or a UE capability message, or any combination thereof.

Aspect 7: The method of any of aspects 1 through 6, further comprising: transmitting a retransmission of the request or the status report for time alignment timer relaxation based at least in part on not receiving a response to the request or based at least in part on a collision with downlink channels or higher priority uplink signaling

Aspect 8: The method of aspect 7, wherein the retransmission of the request or the status report is based at least in part on a link adaptation procedure, a random back-off procedure, a power control procedure, a coverage enhancement procedure, a transmit beam switching procedure, a bandwidth part switching procedure, an uplink carrier switching procedure, or any combination thereof.

Aspect 9: The method of any of aspects 1 through 8, wherein receiving the indication of the time alignment timer relaxation parameters comprises: receiving an indication of one or more timing advance groups, one or more time alignment timers, one or more time alignment timer identifiers, one or more uplink signals, one or more uplink channels, or any combination thereof, enabled for time alignment timer relaxation.

Aspect 10: The method of any of aspects 1 through 9, wherein receiving the indication of the time alignment timer relaxation parameters comprises: receiving an indication of a time window duration for applying the time alignment timer relaxation, a configuration for reduced monitoring occasions for downlink control channel within the time window duration, a configuration of extended discontinuous reception within the time window duration, or any combination thereof.

Aspect 11: The method of any of aspects 1 through 10, wherein receiving the indication of the time alignment timer relaxation parameters comprises: receiving control signaling configuring a set of reference signal resources for measurements associated with time alignment timer management, radio resource management, radio link monitoring, beam management, beam failure detection, link adaptation, power control, or any combination thereof.

Aspect 12: The method of any of aspects 1 through 11, further comprising: applying the time alignment timer relaxation parameters starting no earlier than a last symbol or a last slot of a downlink channel carrying the indication of the time alignment timer relaxation parameters, wherein a cell-specific or UE-specific time offset with respect to the last symbol or last slot of receiving the indication for the time alignment timer relaxation parameters is received via higher layer signaling.

Aspect 13: The method of any of aspects 1 through 12, further comprising: receiving an indication of a start time to apply the time alignment timer relaxation parameters via downlink control information, a medium access control (MAC) control element, system information, or radio resource control signaling, or any combination thereof.

Aspect 14: The method of any of aspects 1 through 13, further comprising: measuring one or more reference signals to obtain one or more reference signal measurements; and determining that the time alignment timer relaxation criteria is satisfied based at least in part on the one or more reference signal measurements, a capability of the UE, and thresholds for the one or more reference signal measurements.

Aspect 15: The method of any of aspects 1 through 14, further comprising: transmitting one or more uplink reference signals, data or control messages in accordance with the time alignment timer relaxation parameters.

Aspect 16: The method of any of aspects 1 through 15, wherein receiving the indication of the time alignment timer relaxation parameters comprises: receiving an indication of the time alignment timer relaxation criteria with relaxation criteria for radio resource management, radio link monitoring, beam management, beam failure detection, or any combination thereof.

Aspect 17: The method of any of aspects 1 through 16, wherein transmitting the request or the status report comprises: transmitting the request or the status report while operating in an idle state, an inactive state, or a connected state.

Aspect 18: The method of any of aspects 1 through 17, wherein the indication of the time alignment timer relaxation criteria or the indication of the time alignment timer relaxation parameters, or both, is received via downlink control information, a medium access control (MAC) control element, radio resource control signaling, a multicast message, or a broadcast message, or any combination thereof.

Aspect 19: The method of any of aspects 1 through 18, wherein transmitting the status report comprises: transmitting the request or the status report for multiple timing advance groups multiplexed in a single transmission of UE.

Aspect 20: A method for wireless communications at a network entity, comprising: transmitting an indication of time alignment timer relaxation criteria for one or more time alignment timers at a UE; receiving a request or a status report for time alignment timer relaxation based at least in part on satisfying the time alignment timer relaxation criteria; and transmitting an indication of time alignment timer relaxation parameters in response to the request.

Aspect 21: The method of aspect 20, wherein transmitting the indication of the time alignment timer relaxation criteria comprises: transmitting an indication of one or more timing advance groups, one or more reference signal types associated with a timing advance group of the one or more timing advance groups, one or more measurement thresholds, one or more filtering coefficients, one or more evaluation metrics, or any combination thereof, for a reference signal measurement to satisfy the time alignment timer relaxation criteria, wherein the indication of the time alignment timer relaxation criteria further indicates a resource configuration and scheduling information for transmission or retransmission, or both, of the request or the status report for time alignment timer relaxation.

Aspect 22: The method of any of aspects 20 through 21, wherein transmitting the indication of the time alignment timer relaxation criteria comprises: transmitting the indication of the time alignment timer relaxation criteria for a timing advance group, one or more time alignment timers, one or more uplink signals, one or more uplink channels, or any combination thereof.

Aspect 23: The method of any of aspects 20 through 22, wherein receiving the request comprises: receiving the request for time alignment timer relaxation for a timing advance group, one or more time alignment timers, one or more uplink signals, one or more uplink channels, or any combination thereof.

Aspect 24: The method of any of aspects 20 through 23, wherein receiving the status report or the request comprises: receiving the status report indicating that a status of the UE satisfies the time alignment timer relaxation criteria for one or more uplink signals or uplink channels in a timing advance group; and receiving the request for the time alignment timer relaxation for the one or more uplink signals or uplink channels in the timing advance group.

Aspect 25: The method of any of aspects 20 through 24, wherein receiving the request or the status report comprises: receiving the request or the status report via a random access message, a configured grant transmission, a small data transmission, a periodic, semi-persistent, or aperiodic channel state information report, a scheduling request, a medium access control (MAC) control message with a dedicated MAC header, an uplink control information message, a UE assistance information message, or a UE capability message, or any combination thereof.

Aspect 26: The method of any of aspects 20 through 25, wherein transmitting the indication of the time alignment timer relaxation parameters comprises: transmitting an indication of one or more timing advance groups, one or more time alignment timers, one or more time alignment timer identifiers, one or more uplink signals, one or more uplink channels, or any combination thereof, enabled for time alignment timer relaxation.

Aspect 27: The method of any of aspects 20 through 26, wherein transmitting the indication of the time alignment timer relaxation parameters comprises: transmitting an indication of a time window duration for applying the time alignment timer relaxation, a configuration for reduced monitoring occasions for downlink control channel within the time window duration, a configuration of extended discontinuous reception within the time window duration, or any combination thereof.

Aspect 28: The method of any of aspects 20 through 27, wherein transmitting the indication of the time alignment timer relaxation parameters comprises: transmitting control signaling configuring a set of reference signal resources for measurements associated with time alignment timer management, radio resource management, radio link monitoring, beam management, beam failure detection, link adaptation, power control, or any combination thereof.

Aspect 29: The method of any of aspects 20 through 28, further comprising: transmitting an indication of a start time to apply the time alignment timer relaxation parameters via downlink control information, a medium access control (MAC) control element, system information, or radio resource control signaling, or any combination thereof.

Aspect 30: The method of any of aspects 20 through 29, wherein transmitting the indication of the time alignment timer relaxation parameters comprises: transmitting an indication of the time alignment timer relaxation criteria with relaxation criteria for radio resource management, radio link monitoring, beam management, beam failure detection, or any combination thereof.

Aspect 31: The method of any of aspects 20 through 30, wherein receiving the request or the status report comprises: receiving the request from a UE operating in an idle state, an inactive state, or a connected state.

Aspect 32: The method of any of aspects 20 through 31, wherein the indication of the time alignment timer relaxation criteria or the indication of the time alignment timer relaxation parameters, or both, is transmitted via downlink control information, a medium access control (MAC) control element, radio resource control signaling, a multicast message, or a broadcast message, or any combination thereof.

Aspect 33: An apparatus for wireless communications at a UE, comprising a processor: memory coupled with the processor; and instructions stored in the memory and executable by the processor to cause the apparatus to perform a method of any of aspects 1 through 19.

Aspect 34: An apparatus for wireless communications at a UE, comprising at least one means for performing a method of any of aspects 1 through 19.

Aspect 35: A non-transitory computer-readable medium storing code for wireless communications at a UE, the code comprising instructions executable by a processor to perform a method of any of aspects 1 through 19.

Aspect 36: An apparatus for wireless communications at a network entity, comprising a processor; memory coupled with the processor; and instructions stored in the memory and executable by the processor to cause the apparatus to perform a method of any of aspects 20 through 32.

Aspect 37: An apparatus for wireless communications at a network entity, comprising at least one means for performing a method of any of aspects 20 through 32.

Aspect 38: A non-transitory computer-readable medium storing code for wireless communications at a network entity, the code comprising instructions executable by a processor to perform a method of any of aspects 20 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive an indication of time alignment timer relaxation criteria for one or more time alignment timers at the UE;
transmit a request or a status report for time alignment timer relaxation based at least in part on satisfying the time alignment timer relaxation criteria; and
receive an indication of time alignment timer relaxation parameters in response to the request or status report.

2. The apparatus of claim 1, wherein the instructions to receive the indication of the time alignment timer relaxation criteria are executable by the processor to cause the apparatus to:
receive an indication of one or more timing advance groups, an indication of one or more reference signal types associated with a timing advance group of the one or more timing advance groups, one or more measurement thresholds, one or more filtering coefficients, one or more evaluation metrics, or any combination thereof, for a reference signal measurement to satisfy the time alignment timer relaxation criteria, wherein the indication of the time alignment timer relaxation criteria further indicates a resource configuration and scheduling information for transmission or retransmission, or both, of the request or the status report for time alignment timer relaxation.

3. The apparatus of claim 1, wherein the instructions to receive the indication of the time alignment timer relaxation criteria are executable by the processor to cause the apparatus to:
receive the indication of the time alignment timer relaxation criteria for a timing advance group, one or more time alignment timers, one or more uplink signals, one or more uplink channels, or any combination thereof.

4. The apparatus of claim 1, wherein the instructions to transmit the status report are executable by the processor to cause the apparatus to:
transmit the status report indicating that a status of the UE satisfies the time alignment timer relaxation criteria for one or more uplink signals or uplink channels in a timing advance group; and
request for the time alignment timer relaxation for the one or more uplink signals or uplink channels in the timing advance group.

5. The apparatus of claim 1, wherein the instructions to transmit the request are executable by the processor to cause the apparatus to:
request for time alignment timer relaxation for a timing advance group, one or more time alignment timers, one or more uplink signals, one or more uplink channels, or any combination thereof.

6. The apparatus of claim 1, wherein the instructions to transmit the request or the status report are executable by the processor to cause the apparatus to:
transmit the request or the status report via a random access message, a configured grant transmission, a small data transmission, a periodic, semi-persistent, or aperiodic channel state information report, a scheduling request, a medium access control (MAC) control message with a dedicated MAC header, an uplink control information message, a UE assistance information message, or a UE capability message, or any combination thereof.

7. The apparatus of claim 1, wherein the instructions are further executable by the processor to cause the apparatus to:
transmit a retransmission of the request or the status report for time alignment timer relaxation based at least in part on not receiving a response to the request or based at least in part on a collision with downlink channels or higher priority uplink signaling.

8. The apparatus of claim 7, wherein the retransmission of the request or the status report is based at least in part on a link adaptation procedure, a random back-off procedure, a power control procedure, a coverage enhancement procedure, a transmit beam switching procedure, a bandwidth part switching procedure, an uplink carrier switching procedure, or any combination thereof.

9. The apparatus of claim 1, wherein the instructions to receive the indication of the time alignment timer relaxation parameters are executable by the processor to cause the apparatus to:
receive an indication of one or more timing advance groups, one or more time alignment timers, one or more time alignment timer identifiers, one or more uplink signals, one or more uplink channels, or any combination thereof, enabled for time alignment timer relaxation.

10. The apparatus of claim 1, wherein the instructions to receive the indication of the time alignment timer relaxation parameters are executable by the processor to cause the apparatus to:
receive an indication of a time window duration for applying the time alignment timer relaxation, a configuration for reduced monitoring occasions for downlink control channel within the time window duration, a configuration of extended discontinuous reception within the time window duration, or any combination thereof.

11. The apparatus of claim 1, wherein the instructions to receive the indication of the time alignment timer relaxation parameters are executable by the processor to cause the apparatus to:
receive control signaling configuring a set of reference signal resources for measurements associated with time alignment timer management, radio resource management, radio link monitoring, beam management, beam failure detection, link adaptation, power control, or any combination thereof.

12. The apparatus of claim 1, wherein the instructions are further executable by the processor to cause the apparatus to:
apply the time alignment timer relaxation parameters starting no earlier than a last symbol or a last slot of a downlink channel carrying the indication of the time alignment timer relaxation parameters, wherein a cell-specific or UE-specific time offset with respect to the last symbol or last slot of receiving the indication for the time alignment timer relaxation parameters is received via higher layer signaling.

13. The apparatus of claim 1, wherein the instructions are further executable by the processor to cause the apparatus to:
receive an indication of a start time to apply the time alignment timer relaxation parameters via downlink control information, a medium access control (MAC) control element, system information, or radio resource control signaling, or any combination thereof.

14. The apparatus of claim 1, wherein the instructions are further executable by the processor to cause the apparatus to:
measure one or more reference signals to obtain one or more reference signal measurements; and
determine that the time alignment timer relaxation criteria is satisfied based at least in part on the one or more reference signal measurements, a capability of the UE, and thresholds for the one or more reference signal measurements.

15. The apparatus of claim 1, wherein the instructions are further executable by the processor to cause the apparatus to:
transmit one or more uplink reference signals, data or control messages in accordance with the time alignment timer relaxation parameters.

16. The apparatus of claim 1, wherein the instructions to receive the indication of the time alignment timer relaxation parameters are executable by the processor to cause the apparatus to:
receive an indication of the time alignment timer relaxation criteria with relaxation criteria for radio resource management, radio link monitoring, beam management, beam failure detection, or any combination thereof.

17. The apparatus of claim 1, wherein the instructions to transmit the request or the status report are executable by the processor to cause the apparatus to:
transmit the request or the status report while operating in an idle state, an inactive state, or a connected state.

18. The apparatus of claim 1, wherein the indication of the time alignment timer relaxation criteria or the indication of the time alignment timer relaxation parameters, or both, is received via downlink control information, a medium access control (MAC) control element, radio resource control signaling, a multicast message, or a broadcast message, or any combination thereof.

19. The apparatus of claim 1, wherein the instructions to transmit the status report are executable by the processor to cause the apparatus to:
transmit the request or the status report for multiple timing advance groups multiplexed in a single transmission of UE.

20. An apparatus for wireless communications at a network entity, comprising:
a processor;
memory coupled with the processor; and
instructions stored in the memory and executable by the processor to cause the apparatus to:
transmit an indication of time alignment timer relaxation criteria for one or more time alignment timers at a user equipment (UE);
receive a request or a status report for time alignment timer relaxation based at least in part on satisfying the time alignment timer relaxation criteria; and
transmit an indication of time alignment timer relaxation parameters in response to the request.

21. The apparatus of claim 20, wherein the instructions to transmit the indication of the time alignment timer relaxation criteria are executable by the processor to cause the apparatus to:
transmit an indication of one or more timing advance groups, one or more reference signal types associated with a timing advance group of the one or more timing advance groups, one or more measurement thresholds, one or more filtering coefficients, one or more evaluation metrics, or any combination thereof, for a reference signal measurement to satisfy the time alignment timer relaxation criteria, wherein the indication of the time alignment timer relaxation criteria further indicates a resource configuration and scheduling information for transmission or retransmission, or both, of the request or the status report for time alignment timer relaxation.

22. The apparatus of claim 20, wherein the instructions to transmit the indication of the time alignment timer relaxation criteria are executable by the processor to cause the apparatus to:
transmit the indication of the time alignment timer relaxation criteria for a timing advance group, one or more time alignment timers, one or more uplink signals, one or more uplink channels, or any combination thereof.

23. The apparatus of claim 20, wherein the instructions to receive the request are executable by the processor to cause the apparatus to:
receive the request for time alignment timer relaxation for a timing advance group, one or more time alignment timers, one or more uplink signals, one or more uplink channels, or any combination thereof.

24. The apparatus of claim 20, wherein the instructions to receive the status report or the request are executable by the processor to cause the apparatus to:
receive the status report indicating that a status of the UE satisfies the time alignment timer relaxation criteria for one or more uplink signals or uplink channels in a timing advance group; and
receive the request for the time alignment timer relaxation for the one or more uplink signals or uplink channels in the timing advance group.

25. The apparatus of claim 20, wherein the instructions to transmit the indication of the time alignment timer relaxation parameters are executable by the processor to cause the apparatus to:
transmit an indication of one or more timing advance groups, one or more time alignment timers, one or more time alignment timer identifiers, one or more uplink signals, one or more uplink channels, or any combination thereof, enabled for time alignment timer relaxation.

26. The apparatus of claim 20, wherein the instructions to transmit the indication of the time alignment timer relaxation parameters are executable by the processor to cause the apparatus to:
transmit an indication of a time window duration for applying the time alignment timer relaxation, a configuration for reduced monitoring occasions for downlink control channel within the time window duration, a configuration of extended discontinuous reception within the time window duration, or any combination thereof.

27. The apparatus of claim 20, wherein the instructions to transmit the indication of the time alignment timer relaxation parameters are executable by the processor to cause the apparatus to:
transmit an indication of the time alignment timer relaxation criteria with relaxation criteria for radio resource management, radio link monitoring, beam management, beam failure detection, or any combination thereof.

28. The apparatus of claim 20, wherein the instructions to receive the request or the status report are executable by the processor to cause the apparatus to:
receive the request from a UE operating in an idle state, an inactive state, or a connected state.

29. A method for wireless communications at a user equipment (UE), comprising:
receiving an indication of time alignment timer relaxation criteria for one or more time alignment timers at the UE;
transmitting a request or a status report for time alignment timer relaxation based at least in part on satisfying the time alignment timer relaxation criteria; and
receiving an indication of time alignment timer relaxation parameters in response to the request or status report.

30. A method for wireless communications at a network entity, comprising:
transmitting an indication of time alignment timer relaxation criteria for one or more time alignment timers at a user equipment (UE);
receiving a request or a status report for time alignment timer relaxation based at least in part on satisfying the time alignment timer relaxation criteria; and
transmitting an indication of time alignment timer relaxation parameters in response to the request.
